(19) United States
(12) Patent Application Publication
(10) Pub. No.: US 2002/0168297 A1
(43) Pub. Date: Nov. 14, 2002

(54) Method and device for dispensing of droplets

(76) Inventors: Igor Shvets, Dublin (IE); Sergei Makarov, Dublin (IE); Alexander Shvets, Dublin (IE); Juergen Osing, Dublin (IE)

Correspondence Address: BIRCH STEWART KOLASCH & BIRCH, PO BOX 747, FALLS CHURCH, VA, 22040-0747, US

(21) Appl. No.: 09/927,355

(22) Filed: Aug. 13, 2001

(30) Foreign Application Priority Data
May 11, 2001 (IE) 2001/0457

(51) Int. Cl. B01L 3/02; B32B 5/02

(52) U.S. Cl. 422/100

(57) ABSTRACT

A conventional syringe pump (10) is used to dispense liquids of less than 5 μl in volume in a dispensing assembly (1). There is a divider barrier formed by a flexible elastomer membrane (5) clamped between an inner part (3) and an outer part (4) of a dispenser (2). The dispenser (2) has a bore divided into a system liquid reservoir (6) and a sample liquid reservoir (7). The system liquid reservoir (6) connects to the pump (10) and the sample liquid reservoir (7) communicates with a nozzle (15) having a dispensing tip (16). The membrane (5) is virtually incompressible and therefore the pump (10) can dispense accurately. Electrostatic drop detachment using an electrode (25) electrically coupled to the dispensing tip (16) and a conducting plate (19) forming a receiving electrode below a substrate (20).

### INTRODUCTION

The present invention could be used in fields such as drug development, pharmaceutical, medical diagnostics, biotechnology, analytical chemistry and others. It is generally related to liquid handling systems and in particular to systems for dispensing and aspirating small volumes of liquids. It is particularly directed to High Throughput Screening (HTS), Polymerase Chain Reaction (PCR), combinatorial chemistry, microarraying, proteomics and other similar tasks. In the area of high throughput screening, PCR, proteomics and combinatorial chemistry, the typical application for such a liquid handling system is in dispensing of small volumes of liquids, e.g. 5 microliters and smaller and in particular volumes around 1 microliter and smaller. The invention is also directed to aspiration of liquids from sample wells so that the liquids can be transferred between the wells. The invention relates also to microarray technology, a recent advance in the field of high throughput screening and genomics. Microarray technology is being used for applications such as DNA and protein arrays: in this technology the arrays are created on glass or polymer slides. The invention can also be used for simultaneous aspiration and dispensing of a multiplicity of liquids. Such a simultaneous aspiration and dispensing can be required for rapid filling of well plates or plates containing blocks of analytical devices for parallel processing of a range of liquids. The well plates filled with a range of liquids can in turn be coupled to a variety of analytical devices such as electrophoresis analyzers, chromatographers, mass spectrometers and others. Many of these areas of application require routine dispensing of consistent droplets of liquids of submicroliter volume, in some cases down to only a few nanoliters in volume. The present invention is also directed to medical diagnostics e.g. for applications such as single nucleotide polymorphism or others.

Development of instrumentation for dispensing of minute volumes of liquids has been an important area of technological progress for some time. Numerous devices for controlled dispensing of small volumes of liquids (in the range of 1 μl and smaller) for ink jet printing application have been developed over the past twenty-five years. More recently, a wide range of new areas of applications has emerged for devices handling liquids in the low microliter range.

The requirements applied to a dispensing system vary significantly depending on the application. For example, the main requirement of a dispensing system for ink jet applications is to deliver droplets of a fixed volume with a high repetition rate. The separation between individual nozzles should be as small as possible so that many nozzles can be accommodated on a single printing cartridge. On the other hand, in this application the task is simplified by the fact that the mechanical properties of the liquid dispensed namely ink are well-defined and consistent. Also in most cases the device used in the ink jet applications does not need to aspire the liquid through the nozzle for the dispenser refill.

For biomedical applications such as High Throughput Screening (HTS), the requirements imposed on a dispensing system are different. The system should be capable of handling a variety of liquids with different mechanical properties e.g. viscosity. Usually these systems should also be capable of aspiring liquids through the nozzle from a well or other source. On the other hand there is not such a demanding requirement for the high repetition rate of drops as in ink jet applications. Another requirement in the HTS applications is that cross contamination, between different wells served by the same dispensing device should be avoided as much as possible.

The most common method of liquid handling for the HTS applications is based on a positive displacement pump such as described in U.S. Pat. No. 5,744,099 (Chase et al). The pump consists of a syringe with a plunger driven by a motor, usually a stepper or servo-motor. The syringe is usually connected to a nozzle of the liquid handling system by means of a flexible polymer tubing. The nozzle is typically attached to an arm of a robotic system that carries it between different wells for aspiring and dispensing the liquids. The syringe is filled with a system liquid such as water. The system liquid continuously extends through the flexible tubing down towards the dispenser. The sample liquid that needs to be dispensed, fills up into the dispenser from the tip. In order to avoid mixing of the system liquid and the sample liquid and therefore cross-contamination, an air bubble or bubble of another gas is usually left between them. In order to dispense the sample liquid from the nozzle, the plunger of the syringe is displaced. Suppose this displacement expels the volume ΔV of the system liquid from the syringe. The front end of the system liquid filling the nozzle is displaced along with it. The system liquid is virtually incompressible. If the inner volume within the flexible tubing remains unchanged, then the volume ΔV displaced from the syringe equals the volume displaced by the moving front of the system liquid in the nozzle. If the volume of the air bubble is small it is possible to ignore the variations of the bubble's volume as the plunger of the syringe moves. Thus, the rear end of the sample liquid is displaced by the same volume ΔV in the nozzle, and therefore the volume ejected from the tip is the same ΔV. This is the principle of operation of such a pump. The pump works sufficiently accurately if the volume ΔV is much greater than the volume of the air bubble.

In practice, the volume of the air bubble changes as the plunger of the syringe moves. Indeed in order to eject a drop from the tip, the pressure in the tubing should exceed the atmospheric pressure by an amount determined by the surface tension acting on the drop before it detaches from the nozzle. This is discussed in more detail below. Therefore, at the moment of ejection the pressure in the tubing increases and after the ejection, it decreases. As common gasses are compressible, the volume of the air or gas bubble changes during the ejection of the droplet and this adds to the error of the accuracy of the system. The smaller the volume of the air bubble, the smaller is the expected error. In other words the accuracy is determined significantly by the ratio of the volumes of the air bubble and the sample liquid droplet to be dispensed. The smaller this ratio is the better the accuracy. For practical reasons it is difficult to reduce the volume of the air or gas bubble to below some one or two microliters and usually it is considerably greater than this. Therefore, this method with two liquids separated by an air or gas bubble and based on a positive displacement pump is not well suited for dispensing a small volume of the order of 1 microliter or lower.

There are also additional limitations on accuracy when sub-microliter and low microliter volumes need to be dispensed. For example, there is an issue of disconnection of the drop from the tip. The drop is attached to the tip and held there by surface tension. In order to overcome this problem the plunger of the syringe is displaced, usually at a high speed. The front end of the sample liquid is displaced along with it. At some moment the syringe pump is stopped nearly instantaneously, and rapid deceleration of sample liquid at the tip separates the droplet from the tip. Even when this method of drop detachment works well, fast movement of the plunger adds to the pressure variation in the gas bubble separating the two liquids through the inertia of the sample liquid in the tip moving with acceleration and deceleration. In practice, this method does not work reliably for drops with volumes smaller than approximately one microliter. To dispense such small drops, the tip is often brought into mechanical contact with the substrate to remove the droplet from the nozzle increasing the chance of cross-contamination. For larger droplets, fast movement of the plunger of the syringe pump as required for the disconnection of the drop from the tip, can cause splattering of the liquid ejected. For many applications this is highly undesirable.

Conventional dispensers based on syringe pumps are susceptible to cross-contamination. As explained above, there is an air bubble separating the sample liquid from the system liquid. As the volume of the air bubble is reduced, the chances of cross-contamination increase, as well as dilution of the sample liquid with the system liquid. Indeed, during the dispensation step, the system liquid can arrive into the part of the dispenser from which the sample liquid has been just expelled. As a result the system liquid can become contaminated with traces of sample liquid. Then, during the aspiration step, the sample liquid can arrive into the part of the dispenser from which the system liquid has been just expelled. As a result, a cross-contamination can occur even if the air bubble separates the two liquids at any given moment.

Other examples of such positive displacement pumps are shown in U.S. Pat. No. 5,744,099 (Chase et al). Similarly the problems of dispensing drops of small volume are also described in U.S. Pat. No. 4,574,850 (Davis) and U.S. Pat. No. 5,035,150 (Tompkins). The particular aspect of the problem addressed in U.S. Pat. No. 5,035,150 is sticking of droplet to the tip. The solution proposed in this patent is to enhance pressure variation in the tubing joining the pump with the dispenser during the drop dispensing. This is achieved by using an electromagnetic valve installed in the line. As the plunger of the positive displacement pump moves forward to expel the sample liquid from the tip, the valve is closed. The pressure builds up in the tubing compressing the air bubble. Then the valve is open allowing the air bubble to expand. The air rushes out of the tip creating an air stream causing the drop off of the sample liquid.

U.S. Pat. No. 5,741,554 (Tisone) describes another method of dispensing submicroliter volumes of liquids for biomedical application and in particular for depositing bodily fluids and reagents on diagnostic test strips. This method combines a positive displacement pump and a conventional solenoid valve. The positive displacement pump is a syringe pump filled with a liquid to be dispensed. The pump is connected to a tubing. At the other end of the tubing there is a solenoid valve located close to the ejection nozzle. The tubing is also filled with the liquid to be dispensed. In this method the piston of the pump is driven by a motor with a well-defined constant speed. The speed determines the flow rate of the liquid from the nozzle provided the solenoid valve is opened frequently enough and the duty cycle between opening and closing of the valve is long enough. The solenoid valve is actuated with a defined repetition rate. The repetition rate of the valve and the flow rate of the pump determine the size of each drop. For example, if the pump operates at a flow rate of 1 μl per second and the repetition rate is 100 open-close cycles per second, then the size of each drop is 10 nl. This method is suitable for dispensing of large number of identical droplets. However, for dispensing of liquids for HTS applications, this method is often inappropriate since it is commonly required to aspire a liquid through the nozzle in small quantities (say 1 μl) and then dispense it in fractions of this quantity, say in a series of only five drops or even a single drop on demand. To avoid mixing of the liquid aspired with the one in the syringe pump, it is probably necessary to place a bubble of gas in the tube with the attendant problems described above.

Without such a bubble, if the solenoid valve open time and/or operating frequency are too small for a given pump flow rate, the pressure in the dispenser will become too great, causing possible rupture or malfunctioning of the system. Another disadvantage of this solution is that the heat from the coil actuating the plunger of the valve may cause the heating effect of the liquid in the valve that can be a serious problem for some applications. Besides, for some regimes of operation the drops may merge, e.g. one drop will be released for every two or three actuations of the valve.

This patent [U.S. Pat. No. 5,741,554; 1998] also describes the combinations of positive displacement pump with a piezo electric dispenser and air-brush dispenser. Drops of microliter volume and smaller can be also generated by the method of electrospray which is mainly used for injection of a liquid into a chemical analysis system such as a mass spectrometer. In most cases the desired output of an electrospray system is not a stream of small drops but rather of ionised molecules. The method is based on supplying a liquid under pressure through a capillary tube towards its end or tip and then a strong electrostatic field is generated at the tip by applying a high voltage, typically over a few kV, between the tip of the capillary and a conductor placed close to it. A charged volume of liquid at the tip of the capillary is repelled from the rest of the capillary by Coulomb interaction as they are both charged with the like charge. This forms a flow of charged particles and ions in the shape of a cone with the apex at the tip of the capillary. A typical electrospray application is described in U.S. Pat. No. 5,115,131 (Jorgenson et al). There are inventions where the droplets emitted from a capillary are charged in order to prevent them from coming together with coagulation. This approach is described in U.S. Pat. No. 5,891,212 (Tang et al) for the fabrication of uniform charged spheres. U.S. Pat. No. 4,302,166 (Fulwyler et al) teaches how to handle uniform particles each containing a core of one liquid and a solidified sheath. In this latter invention, the electric field is applied in a similar way to keep the particles away from each other until the sheath of the particles has solidified. In this invention the particles are formed from a jet by applying a periodic disturbance to the jet. U.S. Pat. No. 4,956,128 (Martin Hommel et al) teaches how to dispense uniform droplets and convert these into microcapsules. A syringe pump supplies the fluid into a capillary. A series of high voltage pulses is applied to the capillary. The size of the droplets is determined by the supply of fluid through the capillary and the repetition rate of the high voltage pulses. The specification does not discuss generation of a single drop on demand. In the U.S. Pat. No. 4,956,128 there is no distinction between the sample liquid and the system liquid. The sample liquid fills up all the volume in the capillary (dispenser), the syringe and the tubing joining the two. U.S. Pat. No. 5,639,467 (Dorian et al) teaches a method of coating of substrates with a uniform layer of biological material. A droplet generator is employed which consists of a pressurised container connected to a capillary. A high constant voltage is applied between the capillary and a receiving gelling solution.

There is one additional relatively recent requirement to a liquid handling system that now becomes increasingly important. It is vital for many applications, that the liquid handling system can dispense liquids containing suspensions of hard particles called beads. Typical beads have the size of some 10 to 100 micron although beads with sizes outside this range can also be used. Some of them are ceramics-based and others are made of ferromagnetic materials, e.g. magnetic particles King FisherTM from Labsystems Oy, Helsinki, Finland. Dispensing liquids with beads in the low microliter volume is a highly challenging task. In addition to all the complications described in detail above, dispensing beads using a solenoid valve can block the seat of the valve. Dispensing the beads using dispensers based on piezoelectric actuators as used in ink jet printing, is also complicated. In this case the beads present inhomogeneities with volume comparable with the volume of a drop produced by many such dispensers. Dispensing magnetic beads presents additional difficulties for the solenoid valve-based dispensers. The reason is that the magnetic beads can aggregate in areas of strong gradient of magnetic field inside the valve. Thus the drops of liquid dispensed are depleted of magnetic beads. The valve itself can malfunction as it accumulates a significant quantity of magnetic material inside.

In summary of the above analysis, the most common method of handling reagents used in HTS and similar applications is based on a positive displacement pump and a gas bubble. The problem is that when dispensing volumes of reagents around 1 microliter or smaller the variation in the volume of the bubble during the dispensation compromises the accuracy. The drop attachment to the tip of the dispenser by surface tension also causes a problem when dispensing submicroliter drops. It has been found difficult to eject small droplets of precisely required volume using this method.

As the size of wells becomes smaller and smaller, the problem of missing the correct well or dropping the liquid reagent at a wrong location of the target substrate becomes more and more significant. In order to improve the accuracy of “shooting” with drops, the tip of the dispenser should be brought closer to the bottom of the well. However, as the distance between the tip and the bottom of the well decreases, the chances of cross contamination increase.

Measurement of the volume of the drops dispensed in the submicroliter range is a formidable task. It would be a highly desirable and valuable feature of a liquid handling instrument to be capable of measuring volumes of individual droplets especially in the submicroliter range, and also detecting the dispensation event that would allow to confirm that the drop has been dispensed.

U.S. Pat. No. 5,559,339 (Domanik) teaches a method for verifying a dispensing of a liquid from a dispenser. The method is based on coupling of electromagnetic radiation that is usually light from a source, to a receiver. As a droplet of liquid travels from the dispenser it obstructs the coupling and therefore the intensity of the signal detected by the receiver is reduced. The mechanism of such an obstruction is absorption of electromagnetic radiation by the droplet. The disadvantage of this method is that the smaller the size of the droplet, the smaller is the absorption in it. Almost certainly the method will not work for fluids that do not absorb the radiation. For a range of applications such as high throughput screening where minute droplets of liquids with a broad range of optical properties need to be dispensed, the methods disclosed in this specification are inappropriate. Further the specification acknowledges that it will only operate satisfactorily with major droplets.

In summary, there is a major problem in finding a suitable way of dispensing submicroliter volumes for applications as described above such as HTS applications. This problem can be said to be currently the bottleneck in changing to assay formats of higher density. Numerous publications in the specialized literature indicate that a technical solution to this problem has not been found so far. For example, according to surveys carried out by the journal Genetic Engineering News (Vol. 20, No. 2, January 2000), absence of an adequate technology for low volume liquid dispensing is named as the number one reason preventing researchers from moving to denser microplates.

The present invention is directed towards providing an improved dispensing assembly to provide a method for dispensing of volumes of liquids as small as 10 nl=10⁻⁸l or even smaller, while at the same time it should be possible to dispense larger droplets such as those as large at 5 microliters or even greater.

Another objective is to provide an assembly where the quantity of the liquid dispensed can be freely selected by the operator and accurately controlled by the dispensing system. The system should be capable of dispensing a drop of one size followed by a drop of a widely differing size, for example, a 10 nl drop followed by a 500 nl one. This is in contrast to for example ink jet printing where the volume of one dispensation is fixed, and dispensations are only possible in multiples of this quantity.

Another objective is to provide a dispensing assembly where cross contamination between different liquids handled by the same dispenser is reduced.

Yet another objective of the invention is to provide a liquid handling device and method in which the dispensing assembly or dispenser does not carry an uncontrolled droplet of liquid attached to its tip during the aspiration. The purpose is to reduce the wastage of valuable liquids and improve the accuracy of the very first dispensation after the aspiration.

Another objective is to reduce the priming volume of the dispensing assembly or dispenser. The priming volume is understood to be the volume of liquid that must be placed inside the dispenser, e.g. aspirated by the dispenser before it can function properly and deliver the dispensations accurately.

Yet, another objective is to reduce the “dead” volume of the dispenser, that is the volume that cannot be returned back into the target substrate after the complete aspirate-dispense cycle. It should be notices that the notions of “dead” volume and priming volume are related although the specific relation depends on the relevant definitions of these terms. The relevant definitions of the terms of “dead” volume and priming volume may to a certain extent depend on the protocol of the aspirate/dispense cycle.

The invention is also directed towards providing a method where the liquid can be dispensed on demand, i.e. one quantity can be dispensed at a required time as opposed to a series of dispensations with set periodic time intervals between them. Yet, the dispensing assembly should also allow for dispensation of doses with regular intervals between subsequent dispensations, for example, printing with reagents.

Another objective of the present invention is to provide a device suitable for dispensing a liquid to a sample well and also for aspiring a liquid from the sample well. The device should be able to control accurately the amount of the liquid aspired into the nozzle of the dispenser from a supply well.

Another objective is to provide a low cost front end of the dispensing assembly that could be disposed of when it becomes contaminated namely the part that comes in direct contact with the reagents dispensed.

Another objective is to provide a method for handling liquids in a robotic system for high throughput screening, proteomics or microarraying that would be suitable for accurate dispensing and aspiring volumes smaller than the ones obtainable with other mainstream technologies.

Yet another objective is to provide means of more accurate delivery of a drop of liquid reagent to a correct target well on a substrate and also to improve the accuracy of delivery of the drop to a correct location in a well forming part of a receiving substrate.

Yet another objective is to provide means for directing doses of liquids into different wells of a sample well plate and means of controlling the delivery address of the dose on the sample well plate to speed up the liquid handling procedure.

Another objective is to provide means for dispensing of small drops of suspensions of particles including magnetic particles such as magnetic beads.

Yet another objective of the invention is to reduce “splashing” as the drop arrives at the well.

Another objective of the invention is to provide information if the drop was dispensed or not, that is validation of the drop dispensation. It is additionally an objective to measure the volume of the drop dispensed.

Yet another objective is to provide means for simultaneous aspiration and simultaneous dispensation of a range of different sample liquids without cross-contamination thus enabling a multi-channel dispenser.

### SUMMARY OF THE INVENTION

The invention is based on the fact that accurate syringe pumps are capable of metering volumes of liquids well below one microliter. The smallest volume that can be metered by a syringe pump depends on the overall volume of the syringe and precision of the mechanical system driving the plunger of the syringe. A syringe pump having an even relatively low accuracy of the mechanical system, is usually capable of ejecting volume of the syringe in at least 1000 steps or more. Therefore, if e.g. a small syringe with the volume of some 10 microliter is used with the pump, then the smallest volume that can be metered by the pump is 10 nl. The volume of 10 nl is some two orders of magnitude smaller than the dispensing limit of current liquid handling systems using syringe pumps. The reason why the accuracy of the syringe pumps is not fully used at present, is explained in the description of the state-of-the-art in this specification.

Our invention uses the potential accuracy of a syringe pump to the full extent. The invention is based on the commonly overlooked fact that many elastomers although being soft and having low Young's modulus, are still virtually incompressible. For example, during a uniaxial strain deformation, as the length of the elastomer increases, its width and breadth decrease keeping its volume almost unchanged. The ratio of the fractional width change to the fractional length change is given by the Poisson ratio. For many elastomers, it is almost equal to 0.5. Those familiar with mechanics of deformations will appreciate that for materials with the Poisson ratio equal to 0.5, the volume change of the material during such deformations is very small. During a deformation caused by an isotropic pressure applied to the material, its volume change is given by the so-called bulk modulus. Bulk modulus is defined as ΔP/(ΔV/V) where ΔV is the volume change of a piece of material having volume V in response to the pressure change ΔP applied to it. High value of the bulk modulus means that the material is almost incompressible during isotropic deformation caused by homogeneous pressure. Once again, many elastomers have very high values of bulk modules greater than the value for water (0.21×10¹⁰ N/m²).

The concept of the dispenser is as follows. There are two reservoirs: the system liquid reservoir and the sample liquid reservoir. They are separated by means of a divider barrier formed by a flexible membrane or an expandable bag. The syringe pump communicates with the system liquid reservoir. The sample volume reservoir communicates with a nozzle. The system liquid reservoir is preferably entirely filled with a liquid such as water. As most liquids are practically uncompressible, the volume of the system liquid reservoir remains constant irrespective of the position of the plunger of the syringe pump. As explained above, the volume of the material of the membrane or the expandable bag positioned between the system and sample reservoirs is also practically constant. Therefore, by moving the plunger, we can expel a well-defined volume of sample liquid from the nozzle that is exactly equal to the volume displaced by the syringe pump. This sample liquid could be separated from the nozzle to form a drop if the expelled volume is large enough or alternatively it will be suspended at the tip of the nozzle. We then detach the droplet by electrostatic drop off, by sending a compression wave through the sample liquid by directly contacting the substrate by the nozzle.

The invention could be split into four constituent parts:

1. Means for control of the volume of the sample liquid expelled from the nozzle,

2. Means for the drop detachment from the nozzle,

3. Means for electrostatic droplet navigation, and

4. Means for measurement of the volume of the drop dispensed and confirmation of the dispensation event.

Parts 3 and 4 can only be used if the drop detachment is based on electrostatic pull off.

These four parts effectively correspond to the four different stages in the drop dispensing process. They are described more in detail below.

Means for controlling the volume of the droplet is based on a syringe pump. The pump is usually driven by a motor/actuator. The syringe pump is hydraulically connected to a dispenser by means of non-expandable tubing. A nozzle terminating in a tip is hydraulically connected at the other end of the dispenser. At least one flexible membrane or an expandable bag is installed in the dispenser to separate the system and sample liquids and it forms a divider barrier between the two liquids. The space between the syringe and the membrane/expandable bag is preferably entirely filled up with a system liquid such as water. The space on the other side of the membrane (or the expandable bag) forms the reservoir for the sample liquid terminating in the dispensing tip. There are also optional elements such as pressure sensor, a release valve and system liquid supply means all hydraulically connected to the syringe pump. It is highly advantageous that all the boundaries of the volume for the system liquid between the syringe pump and the dispenser consist of nonexpendable elements except for the membrane or expandable bag. Therefore, the flexible membrane or the expandable bag is the only element that can accommodate the excess system liquid expelled from the syringe pump. As the volume of the membrane/expandable bag is unchanged, the volume of the sample liquid expelled from the dispensing tip is equal to the volume of the system liquid expelled from the syringe.

One can appreciate that since there are no valves in contact with the sample liquid, liquids containing particles, beads and inhomogeneities can be dispensed. There is no danger of blocking of any valve seat etc. In particular, liquids with magnetic beads can be dispensed as there is no gradient magnetic field in a dispenser according to the invention unlike in a dispenser employing a solenoid valve.

If the volume of the sample liquid expelled from the dispensing tip is small, e.g. 500 nl or smaller, the drop may not get detached from the tip. Instead it will be suspended at the tip by surface tension. Then the volume expelled can be transferred to the target substrate by bringing the suspended drop into a mechanical contact with the target substrate. This however may result in cross-contamination. To reduce the risk of cross-contamination, a number of non-contact methods are proposed in this invention. They are based on sending a compression wave to reach the dispensing tip and the droplet of the sample liquid suspended at the tip. If the compression wave has sufficiently large amplitude, it can detach the suspended drop from the tip. The compression wave can be generated by a piezo actuator or magnetic actuator that is mechanically coupled to the sample liquid reservoir, the system liquid, the nozzle, or, alternatively coupled to more than just one of these areas. Alternatively, a magnetostrictive actuator could be employed to excite a compression wave in the sample liquid. The principle of the magnetostrictive actuator is based on a change in dimensions of a magnetostrictive element in the actuator in response to change in magnetic field applied to it. Therefore, by generating a pulse of magnetic field around the actuator, one can excite mechanical compression wave in the sample liquid if the actuator is coupled mechanically into the dispenser.

In order to facilitate the detachment of the drops from the nozzle, electrostatic drop off is used. For this purpose we generate a pulse of a strong electrostatic field at the nozzle. This could be done e.g. by generating a pulse of high voltage from the voltage controller. The electrostatic field polarizes the drop at the nozzle and in this way an electrostatic repulsive force is created between the drop and the nozzle. This force causes the drop off. Therefore, the method of dispensing small drops using electrostatic drop off could be summarized as follows: we first grow the drop of required volume using a syringe pump. We then generate a pulse of a strong electrostatic field at the dispensing tip. As the value of the field increases during the pulse from the initial value to the final pre-set value, at some stage it will exceed the critical value causing the drop off. The critical value is mainly determined by the volume of the drop to be dispensed, diameter of the nozzle and surface tension.

Numerous arrangements could be devised for generating electrostatic field in the vicinity of the dispensing tip. The field is created between the dispensing tip and the receiving electrode or a plurality of receiving electrodes positioned in the vicinity of the tip. For practical reasons it can be advantageous that either liquid in the dispenser or the receiving electrode/electrodes are connected to the ground potential and the remaining of the two elements is connected to a high potential. Numerous arrangements of the receiving electrodes could be devised.

As the size of the wells receiving drops gets smaller and smaller, it is increasingly more difficult to ensure that the drop reaches the correct destination as it is ejected from a liquid handling system. For applications such as high-density arrays, the separation between the subsequent drops covering the substrate should be as small as 0.2 mm. In this invention there are means of controlling the destination of the drop based on the electrostatic forces acting on the drop as it travels between the nozzle and the well. These means can be used in conjunction with electrostatic drop off.

In one case, for generating the electrostatic field as described above we use a drop off or receiving electrode positioned underneath the well. For accurate navigation, the size of the electrode is smaller than the size of the well. It may be advantageous to have the drop off or receiving electrode in the shape of a tip to produce the strongest electric field at the centre of a destination well. The electrode produces a strong electric field underneath the well attracting the drop to the required destination position (e.g. centre of the well). The receiving electrode may be attached to an arm of a positioner capable of moving it underneath the well plate and pointing to the correct destination well. Alternatively, the sample well plate may be repositioned above the receiving electrode in order to target a different well. It may well be necessary to move the tip and receiving electrode synchronously. It may be advantageous to have a module equipped with a number of receiving electrodes that could be connected to the high voltage supply independently. The distance between the electrodes could be e.g. identical to the distance between the centers of the wells in a well plate. In this case the drops could be navigated to different wells without actually moving the tip or the receiving electrode. This could be achieved by selectively charging the correct electrode to send the droplet in the required direction.

In another embodiment, the deflection electrodes are positioned along the path between the nozzle and the destination well. The electrodes are charged by means of a high voltage applied to them. As the drops leaving the dispensing tip are charged by the voltage between the tip and the receiving electrode, they will be deflected by the deflection electrodes.

It is important to realize that during the electrostatic drop off, the electrostatic force acting on the drop could be much greater than the gravity force. In this case as the drop travels between the nozzle and the substrate, the direction of the path is given effectively by the direction of the electrostatic field, i.e. the field line initiated at the dispensing tip.

For independent measurement of the drop volume, one could use means described in EP application No 00650123.3. These include an electromagnetic balance based on a coil suspended in a magnetic field or another suitable balance.

If electrostatic field is used for the drop off, one could also use all the methods of measurement of volume of the drop that are based on measuring its charge. These methods employ Faraday pail or bottomless Faraday pail. One could independently measure the electrostatic field required for the drop off and then work out from the field, volume of the drop using calibration dependencies. This could be achieved through independent monitoring of moment of the drop off while the electrostatic field in the vicinity of the nozzle is ramped up to cause the drop off. Monitoring of the moment of the drop off could be achieved by e.g. coupling electromagnetic radiation from a source to a detector through the drop suspended at the dispensing tip and monitoring the change in signal received by the detector caused by the drop off. One could also monitor the moment of drop off by using a Faraday pail. These methods are described in detail in EP application No 00650123.3 and U.S. application Ser. No. 09/709,541.

### DETAILED DESCRIPTION OF THE INVENTION

The invention will be more clearly understood from the following description of some embodiments thereof given by way of example only with reference to the accompanying drawings in which:

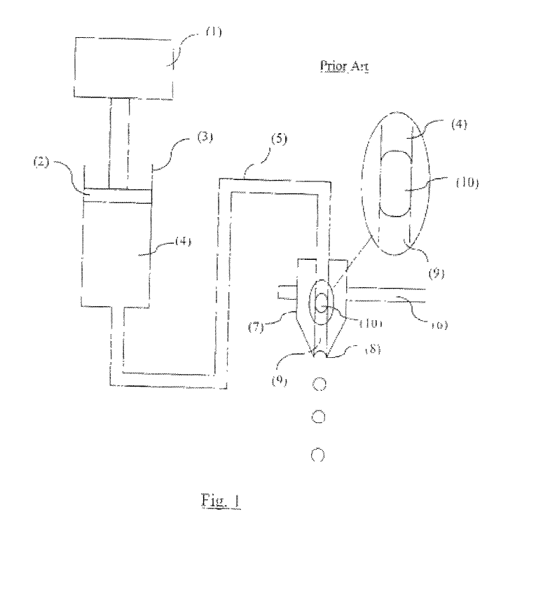

FIG. 1 is a diagrammatic view of a positive displacement pump arrangement of the prior art;

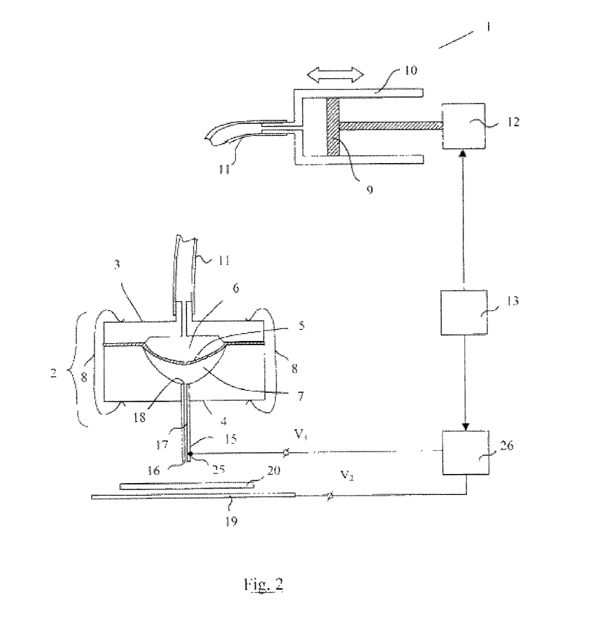

FIGS. 2, 3 and 4 are diagrammatic views of a dispensing assembly according to the invention;

FIGS. 5, 6 and 7 illustrate a particular embodiment of dispenser for three different positions in use;

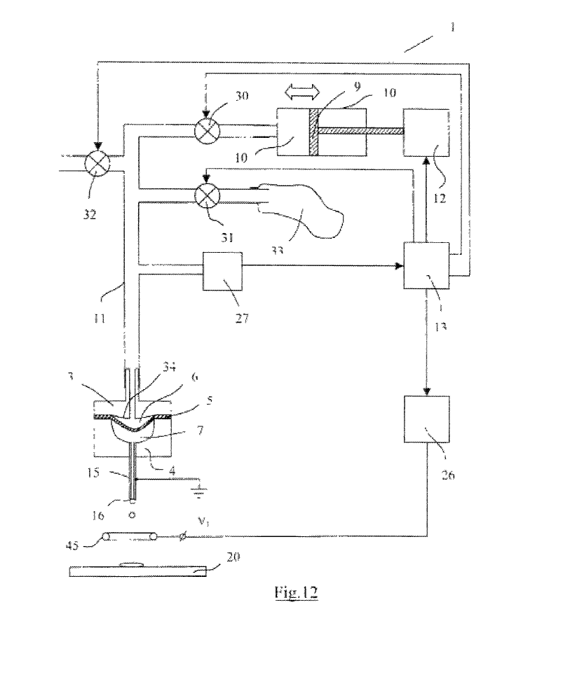

FIGS. 8, 9 and 10 illustrate diagrammatically another alternative construction of dispenser.

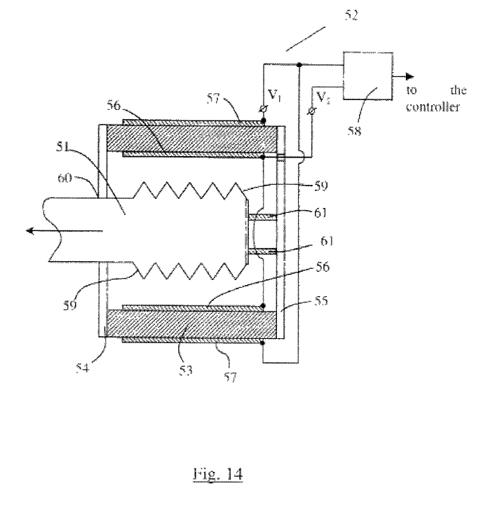

FIG. 11 illustrates another construction of dispenser.

FIG. 12 illustrates an alternative construction of dispensing assembly;

FIG. 13 illustrates another construction of dispensing assembly;

FIG. 14 illustrates a compression wave generator utilising piezo actuators;

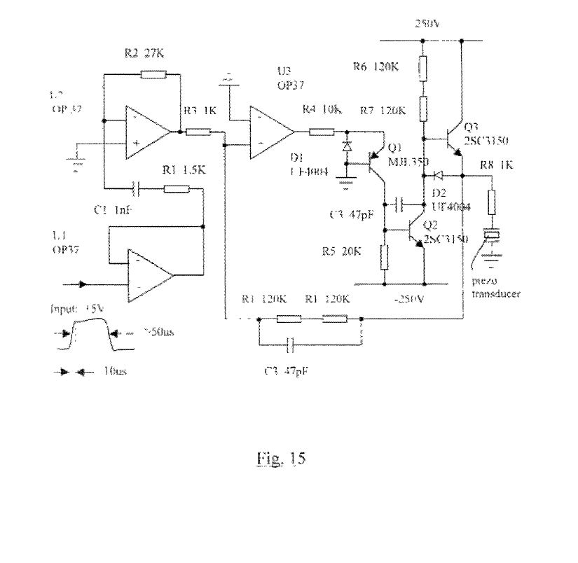

FIG. 15 is a circuit of a voltage pulse generator;

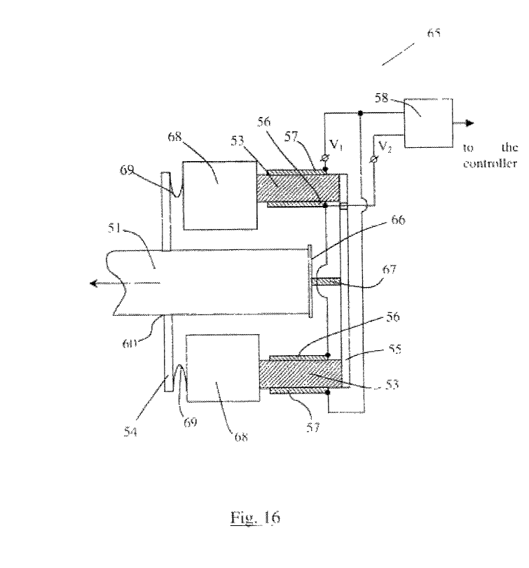

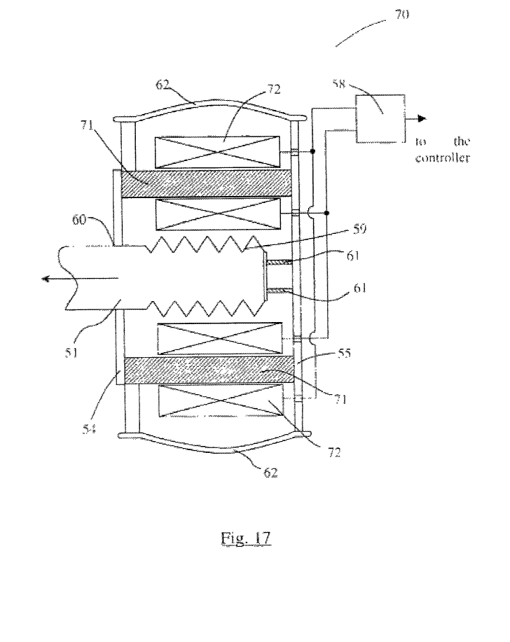

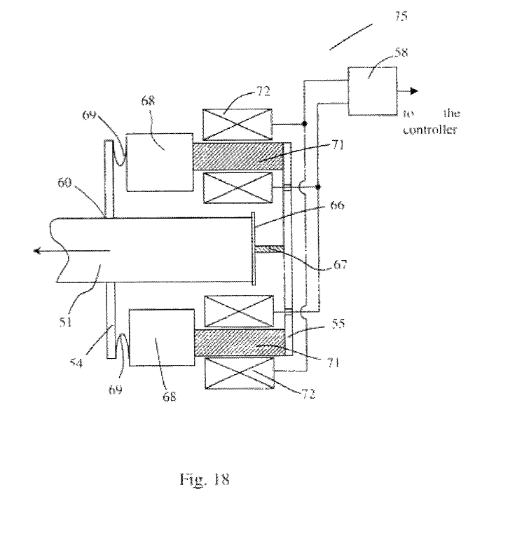

FIG. 16 is another compression wave generator;

FIG. 17 is a part sectional view of a compression wave generator;

FIG. 18 is a part sectional view of another embodiment of a compression wave generator;

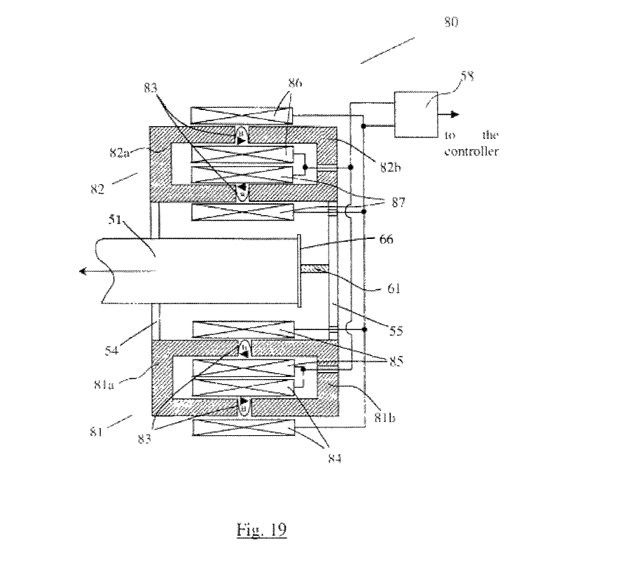

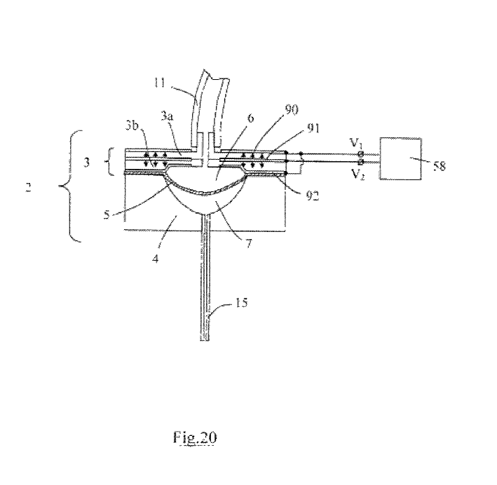

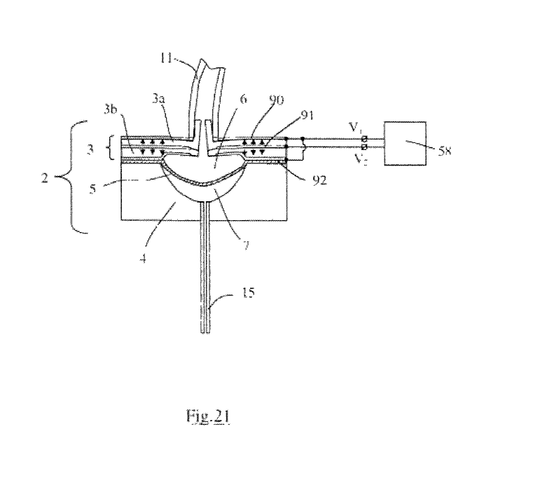

FIG. 19 is a part sectional view of a compression wave generator utilising a magnetic coil actuator;

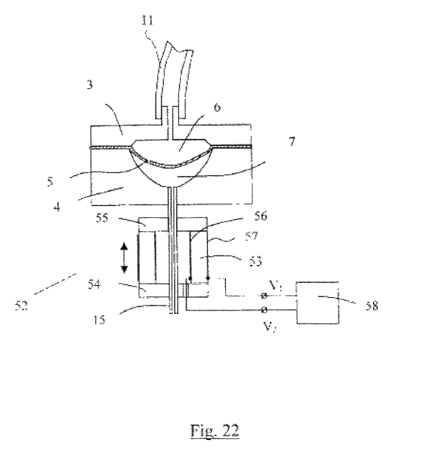

FIG. 20 is a view of another dispenser;

FIG. 21 is a diagrammatic view of a dispenser of the invention;

FIG. 22 is a diagrammatic view of a dispenser of the invention;

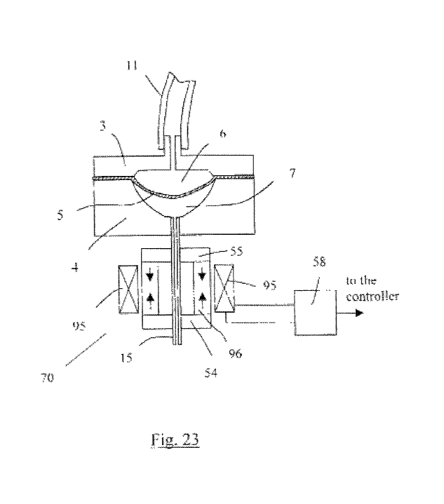

FIG. 23 is a diagrammatic view of a dispenser of the invention;

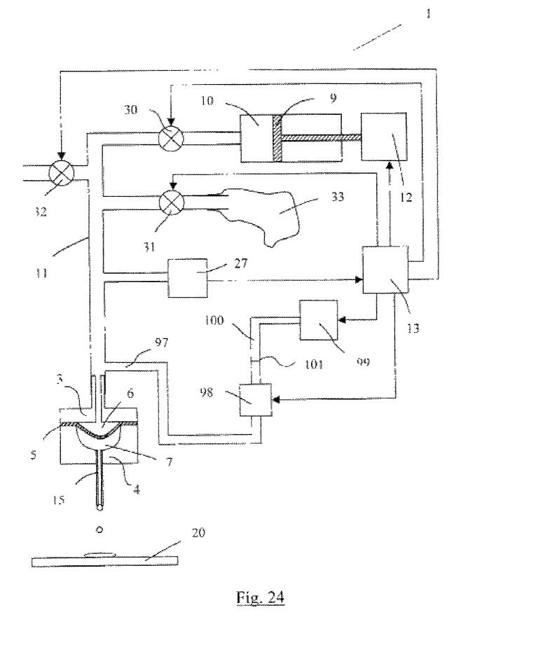

FIG. 24 is a diagrammatic view of a dispensing assembly of the invention;

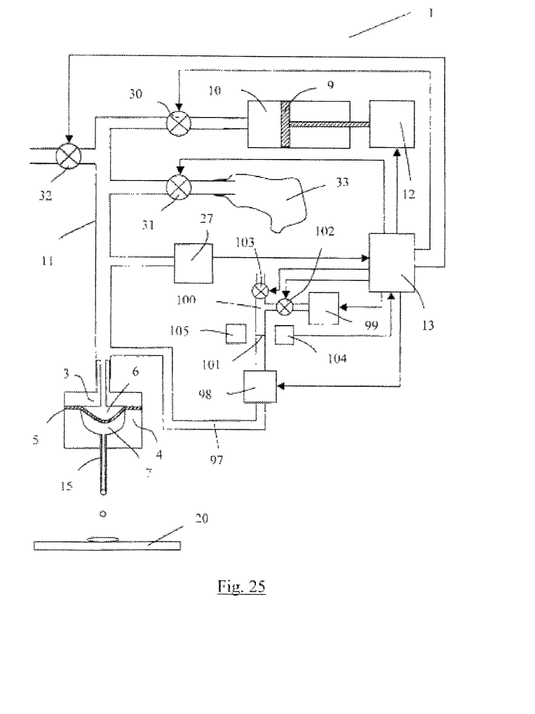

FIG. 25 is a diagrammatic view of a dispensing assembly of the invention;

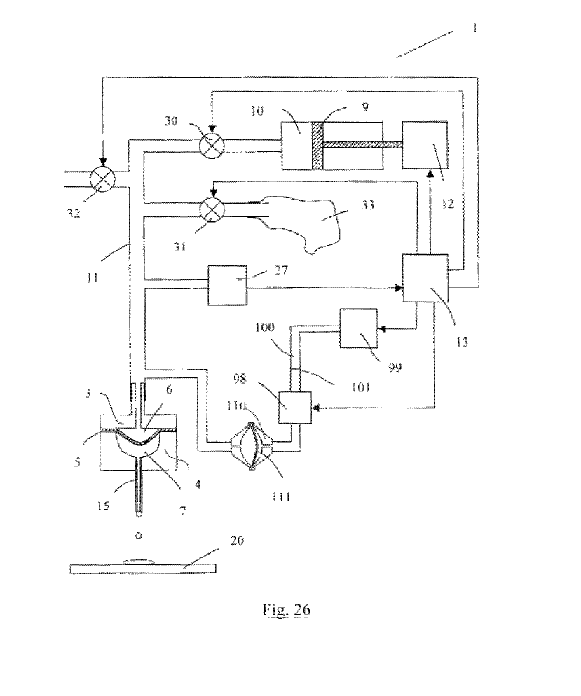

FIG. 26 is a diagrammatic view of a dispensing assembly of the invention;

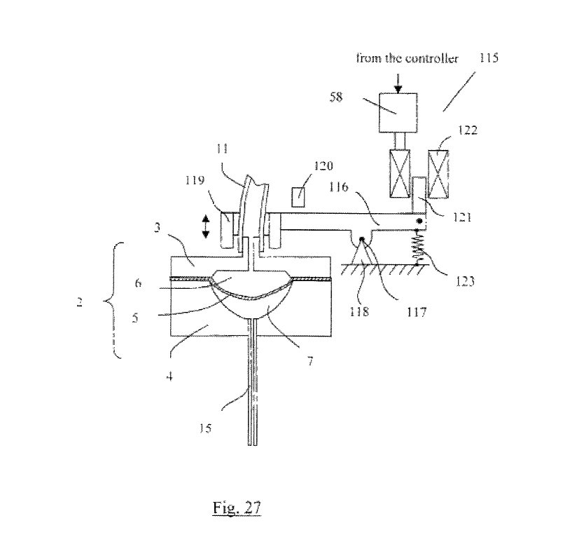

FIG. 27 is a diagrammatic view of a dispenser of the invention;

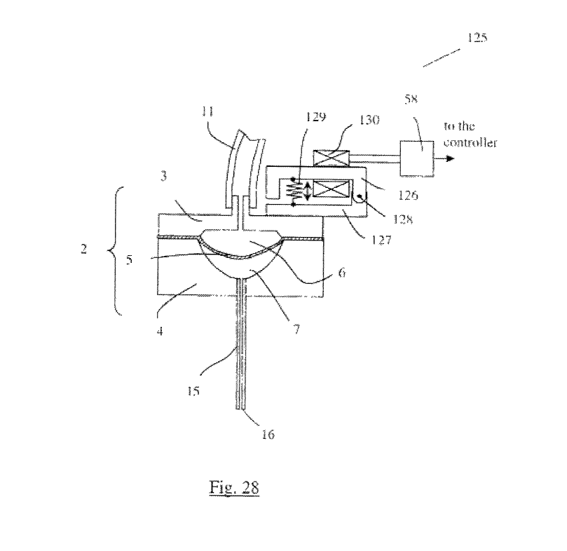

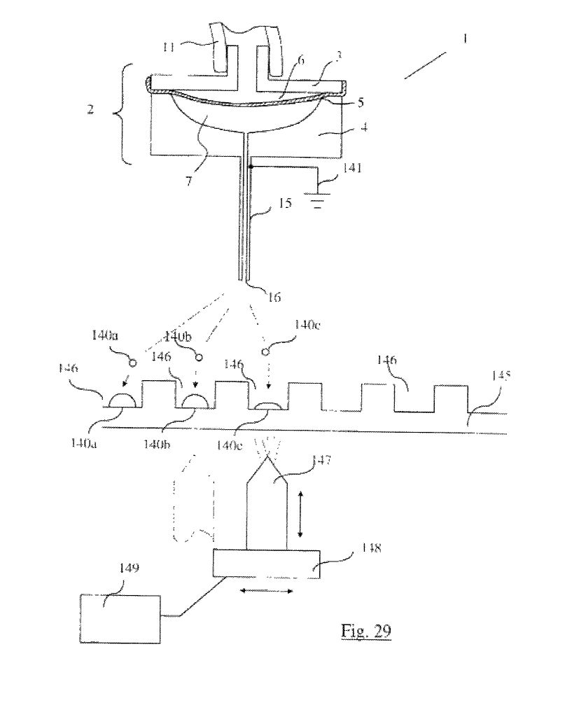

FIG. 28 is a diagrammatic view of a dispenser of the invention;

FIG. 29 is a diagrammatic view of part of a dispensing assembly with droplet navigation;

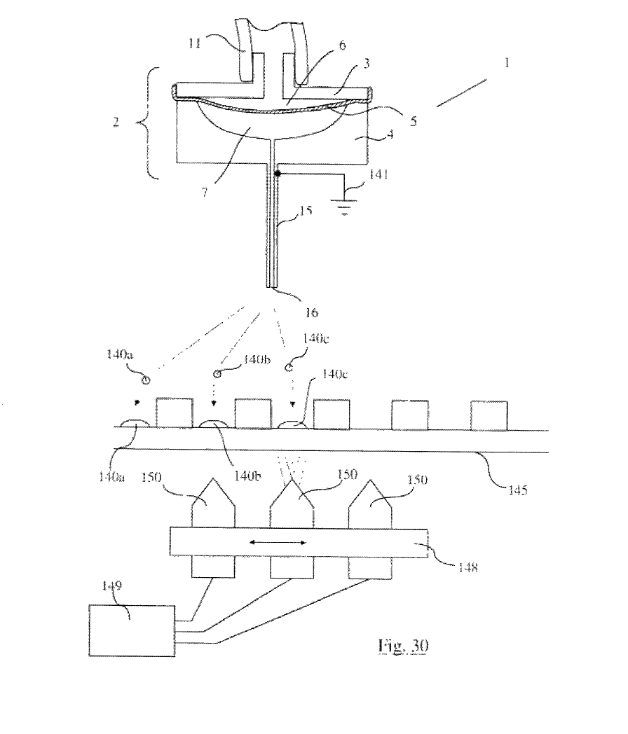

FIG. 30 is a diagrammatic view of part of a dispensing assembly with droplet navigation;

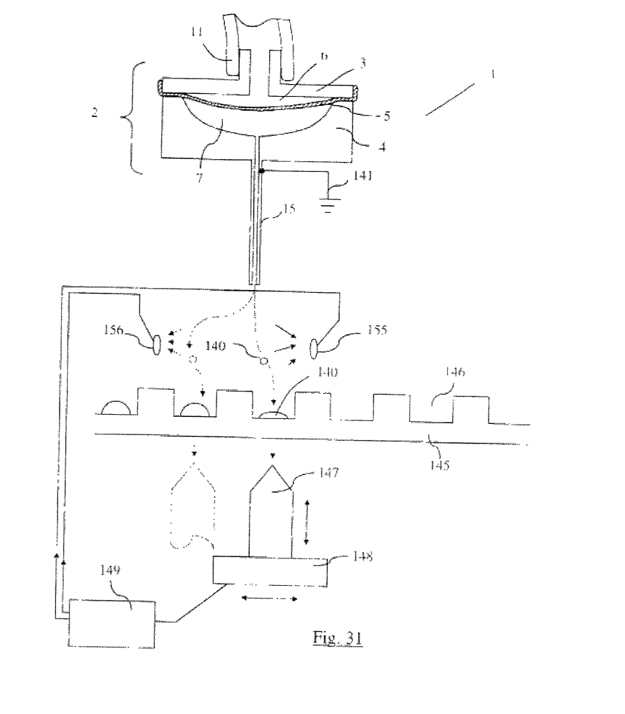

FIG. 31 is a diagrammatic view of part of a dispensing assembly with droplet navigation;

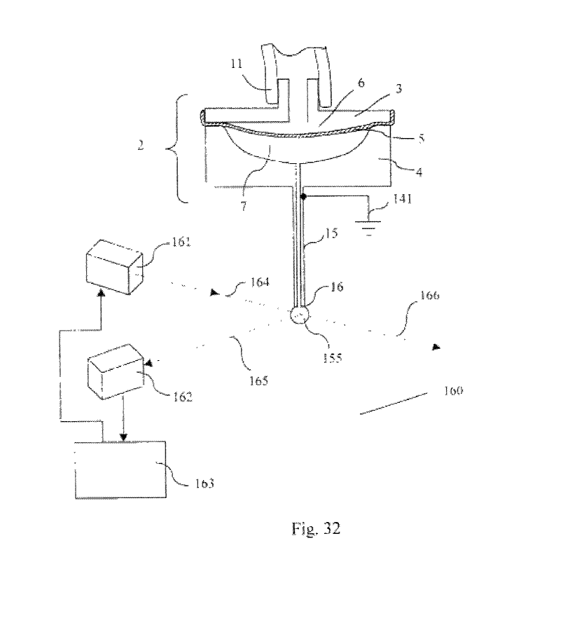

FIG. 32 is a diagrammatic view of part of a dispensing assembly with drop detection;

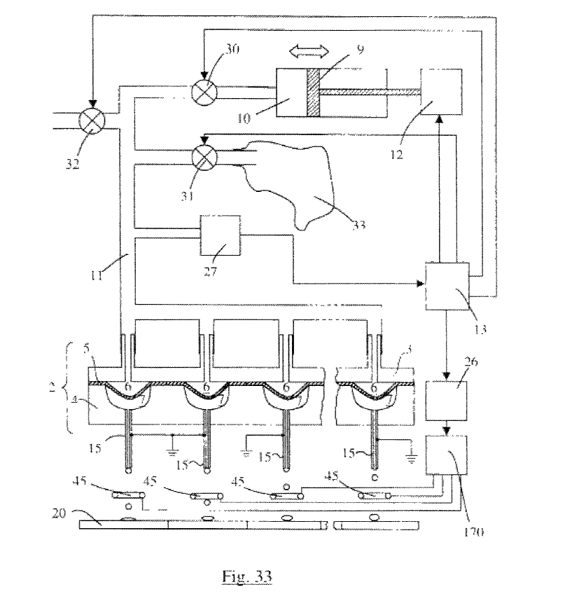

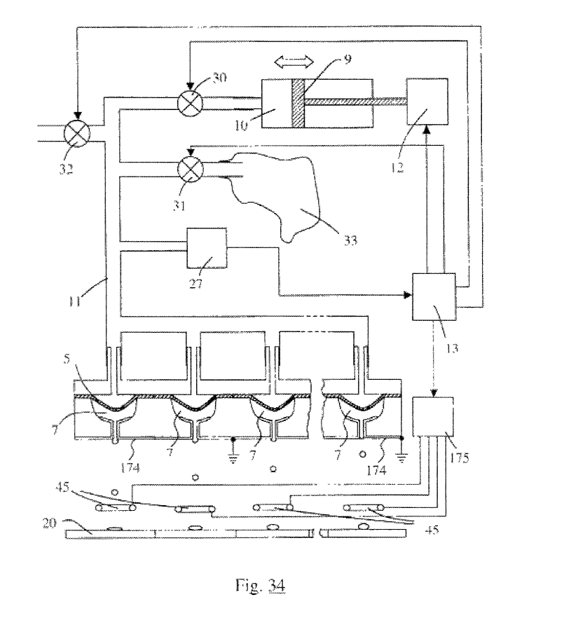

FIG. 33 is a diagrammatic view of a dispensing assembly for multi-droplet dispensing;

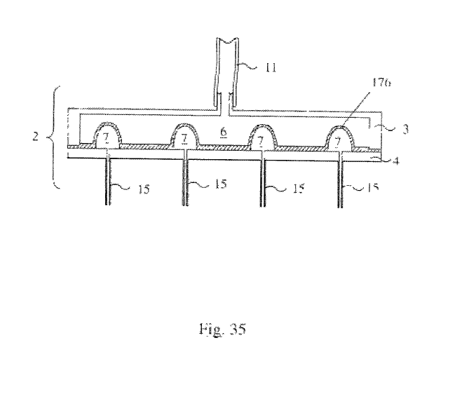

FIG. 34 is a diagrammatic view of a dispensing assembly for multi-droplet dispensing;

FIG. 35 illustrates the dispenser of another multi-droplet dispensing assembly; and

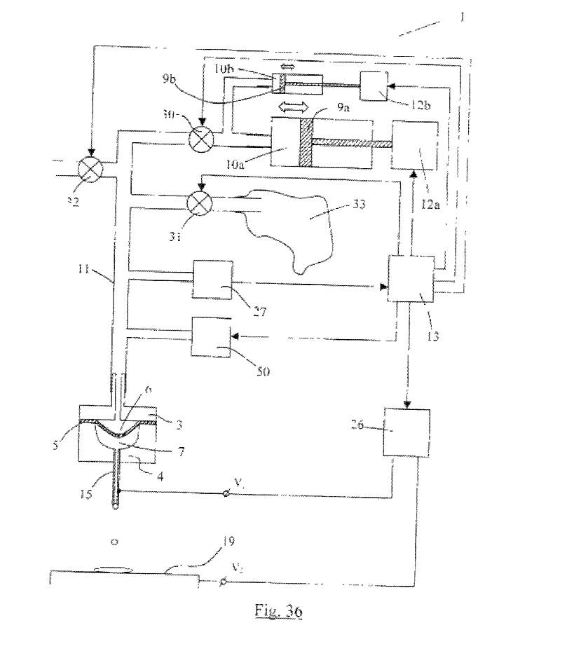

FIG. 36 is a diagrammatic view of yet another dispensing assembly.

Referring to the drawings and initially to FIG. 1 there is illustrated the prior art showing a conventional method of liquid droplet production using a positive displacement pump. There is illustrated a motor (1) driving a piston (2) of a positive displacement pump (3) containing a system liquid, such as water (4) connected by flexible tubing (5) to a robotic arm (6) carrying a nozzle (7) having a tip (8) into which the tubing (5) projects. A sample liquid (9) is contained in the nozzle (7) adjacent to the tip (8) and separated from the water (4) by a gas bubble (10). The motor (1) which is usually a stepper or servo motor will each time move the piston (2) to dispense the sample liquid.

Referring to FIG. 2 there is illustrated dispensing assembly 1 according to the invention. The dispensing assembly 1 comprises a dispenser 2 having an inner part 3 and a nozzle mounting part 4. There is a divider barrier formed by a flexible elastomer membrane 5 clamped between the inner part 3 and nozzle mounting part 4 of the dispenser by means of the clamping means, in this embodiment, spring clips 8. The elastomer membrane 5 hermetically divides a main bore for the dispenser 2 into two bore sections, namely, a system liquid reservoir 6 and the sample liquid reservoir 7. The system liquid reservoir 6 communicates with a syringe pump 10 by means of a nonexpendable tubing 11. The syringe pump 10 is controlled by a syringe pump motor 12 that is in turn controlled by a controller 13. There is a nozzle 15 mounted on the dispenser body and terminating in a dispensing tip 16. The nozzle 15 has a nozzle bore 17 with a nozzle entrance 18 communicating with the sample liquid reservoir 7 of the main bore. The nozzle 15 is inserted in the dispenser 2 preferably in such a way that it does not protrude significantly inside the sample liquid reservoir 7. The inner surface of the sample liquid reservoir 7 is preferably smooth.

There is further provided means for drop detachment from the nozzle 15. The means comprises a conducting plate 19 forming a drop-off or receiving electrode positioned underneath a substrate 20. An electrode 25 electrically coupled to the dispensing tip 16 in this embodiment mounted in it is connected to a high voltage source 26 also connected to the receiving electrode 19. The high voltage source 26 is also controlled by the controller 13 generates electrostatic field between the dispensing tip 16 and the substrate 20. It will be appreciated that while the inner part 3 and the nozzle part 4 are clamped together tightly by clamping means, alternatively, they could be bonded together e.g. by a glue. It should be appreciated that the substrate 20 could be made of a conducting material and thus form the receiving electrode. In this case the high voltage source 26 should be directly connected to the substrate 20.

In a typical embodiment, the flexible membrane is made of a material such as Latex with the thickness of up to 0.5 mm, although membranes with greater thickness can also be used. The nozzle is a stainless steel capillary with the internal diameter of 0.07 to 0.4 mm, although values outside this range can also be used. In a typical embodiment the system liquid reservoir and sample liquid reservoir have axial symmetry. In the embodiment shown in FIG. 2, the axes of the system liquid reservoir and the sample liquid reservoir coincide with the axis of the nozzle, although other embodiments, in which this is not the case, can readily be designed. The walls of the sample liquid reservoir are preferably smooth so that when the membrane is fully extended to expel the sample liquid from the dispenser, it applies tightly to the walls of the dispenser to reduce the dead volume in the dispenser. The smooth inner walls of the sample liquid reservoir also reduce the chances of making a puncture in the membrane. Typically the diameter of the sample liquid reservoir is some 0.4 to 4 mm and its depth is in the range of 0.4 to 4 mm although values outside this range can be used depending on the desired volume of dispensation. In a typical embodiment, the inner part 3 and the nozzle mounting part 4 of the dispenser are formed of a plastics material by injection moulding or another suitable mass production technique. The dispenser 2 then becomes essentially a low-cost, disposable element within the dispensing assembly.

In the embodiment above, the conducting plate 19 can also be used advantageously during the aspiration phase. At the end of the aspiration, when the nozzle 15 is removed from the source of the sample liquid from which the sample liquid has been aspired, a drop of sample liquid may get attached to the tip 16 of the nozzle. This drop is undesirable for many applications. The volume of this drop is difficult to control since it depends on the surface tension of the specific sample liquid aspired. This drop contributes to the wastage of valuable sample liquid and also can have a detrimental effect on the accuracy of the very first dispensation as it can add to the volume of the first dispensation. The dispensing assembly 1 can be used to obviate this problem. After the aspiration, when the nozzle 15 is removed from the source of the sample liquid (e.g. well plate with the sample liquid), a strong electric field is applied at the tip 16 of the dispenser. This field removes any such droplet attached to the tip 16. The field is generated by means of a high voltage applied between the receiving electrode and the nozzle. It is proposed that in a typical application, a robotic arm as in the prior art will remove the nozzle of the dispenser from the sample well plate by only a some 1 to 5 mm in a vertical direction and then the voltage is applied to the receiving electrode and the nozzle to transfer sample liquid attached to the nozzle back exactly into the same well from which it has been aspired. This avoids unnecessary wastage of the sample liquid.

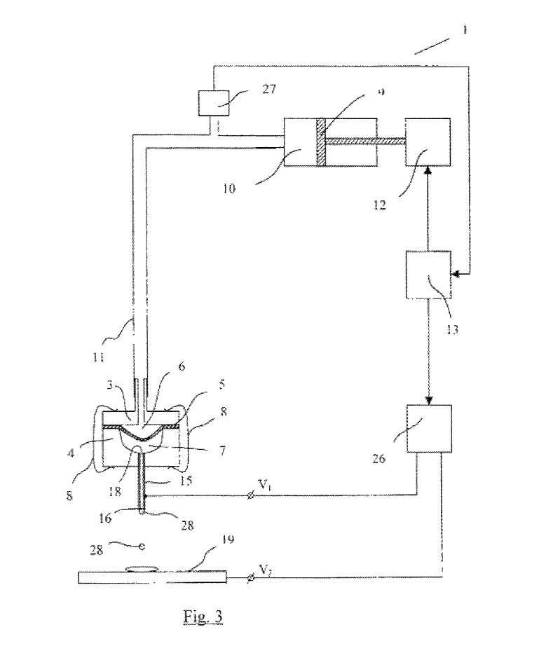

Referring to FIG. 3, there is illustrated another dispensing assembly, again identified by the reference numeral 1 where parts similar to those described in FIG. 2 are identified with the same numerals. The only difference is that there is a pressure sensor 27 attached to the system liquid reservoir 6 and the controller 13. The pressure sensor e.g. 24 PCGFM1G manufactured by Honeywell Inc. could be used. The readings from the pressure sensor 27 are sent to the controller 13 during the aspiration and dispensation. The prime purpose of the pressure sensor 27 is to ensure that the membrane 5 and other parts of the system liquid reservoir 6 are not destroyed by means of excess pressure produced by the syringe pump 10. During the dispensing, the pressure in the system liquid reservoir 6 will gradually rise from the value essentially equal to the atmospheric pressure when the membrane 5 is not bent, i.e. stretched straight. This increase above the atmospheric pressure is due to additional pressure resulting from the stretched membrane 5 being bent into the sample liquid reservoir 7. Once the membrane 5 is fully pressed against the wall of the sample liquid reservoir 7, the excess system liquid further expelled from the syringe pump 10 cannot be accommodated by the dispenser any more and therefore the pressure in the system liquid reservoir 6 will rise sharply if the syringe pump 10 continues expelling the system liquid. To prevent destroying the membrane 5, tubing 11 or syringe pump 10 itself, the readings from the pressure sensor 27 are continuously taken by the controller 13. The reading of pressure P₀ corresponding to the membrane being fully extended into the sample liquid reservoir 7 could be recorded by the controller 13 using a calibration run of the dispensing assembly 1. Then the threshold limit pressure Pₜₕ could be selected as e.g. Pₜₕ=1.1*P₀ or another suitable value marginally above the value of P₀. Thus if the pressure in the system reaches the value of Pₜₕ, the controller 13 stops advancement of the syringe pump's plunger 9 and discontinues expulsion of the system liquid from the pump 10. This would then indicate that the dispenser is empty of the sample liquid. Similarly during the aspiration, once the pressure in the system liquid reservoir has been reduced to the atmospheric pressure, the membrane is stretched straight. It could be beneficial to stop moving the plunger of the syringe at this moment. The pressure range at which the syringe pump should stop moving during the dispensing and aspiration of liquid can be selected depending on the specific configuration of the dispenser. In some instances it may be beneficial to operate the dispensing assembly in such a way that the membrane is continuously extended into the sample liquid reservoir. This is described in detail below with reference to FIG. 33. In the embodiment shown in FIG. 3, the substrate also serves as a receiving electrode 19. Numeral 28 indicates schematically drops of the sample liquid dispensed.

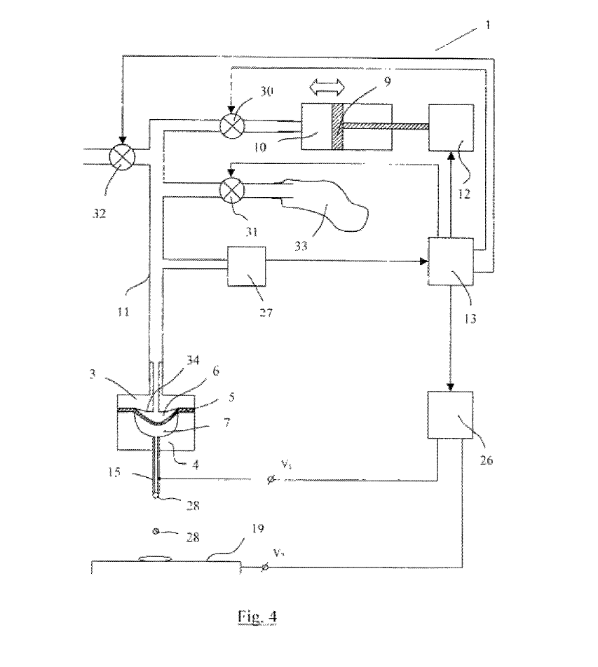

Referring to FIG. 4, there is illustrated a further dispensing assembly, again identified by the reference numeral 1, in which parts similar to those of FIGS. 2 and 3 are indicated by the same numerals. The main difference between the dispensing assemblies 1 is that there are valves 30, 31 and 32 in this embodiment connected to the controller 13, all of which valves can be electrically opened and closed by the controller 13. Valve 30 separates the system liquid reservoir 6 from the syringe pump 10. The valve 31 separates the system liquid reservoir 6 from a system liquid supply 33. Finally, the valve 32 separates the system liquid supply 33 from the outside atmosphere. The system liquid supply 33 is a container filled with a system liquid. This could be e.g. a flexible bag preferably with the volume greater than the volume of the system liquid reservoir communicating with the latter. Those skilled in the art can appreciate that by manipulating the valves 30, 31 and 32 and the syringe pump, one can fill in the system liquid reservoir 6 with the liquid and expel any air bubbles from it. It is clear from the discussion above that it is preferable to expel bubbles of air or gas from the system liquid reservoir 6. Once the system liquid reservoir 6 is filled up with a system liquid, operation of the dispensing assembly is as described above.

Alternatively the system liquid supply could consist of an additional syringe or another syringe pump filled with system liquid. The process of filling the system liquid reservoir with the system liquid and expelling gas bubbles could be simplified if the system liquid supply indeed comprises a separate syringe pump.

In this particular embodiment the inner part 3 and nozzle part 4 are bonded together with the membrane bonded in between.

Further, the inner surface 34 of the inner part 3 of the dispenser 2 facing the membrane 5 is not flat but convex.

Referring now to FIGS. 5 to 7, there is illustrated an alternative construction of dispenser which is substantially identical to the dispenser already described with reference to the previous FIGS. 2 to 4 and is thus identified by the same reference numeral 2. In this embodiment, the inner part 3 is connected to the nozzle mounting part 4 by clamping screws 35. The nozzle mounting part 4 also incorporates an annular rim 36 for the sealing of the membrane 5 between the parts. It will also be noted that the inner surface 34 of the inner part 3 facing the membrane 5 is concave.

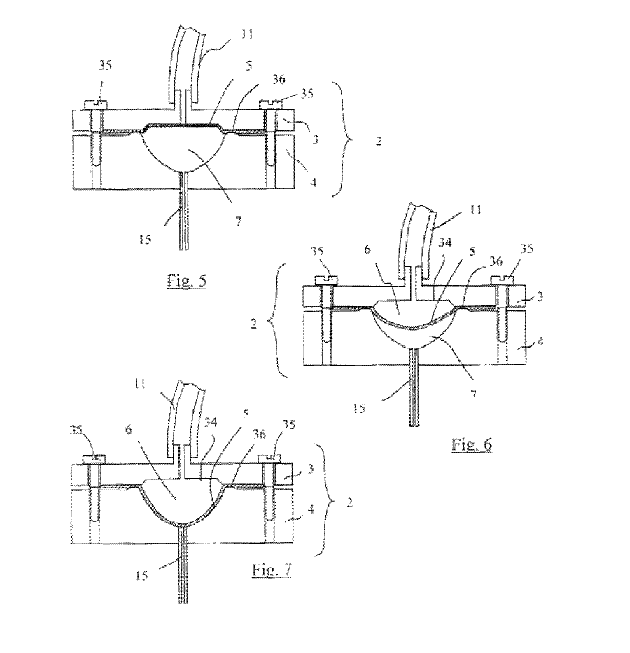

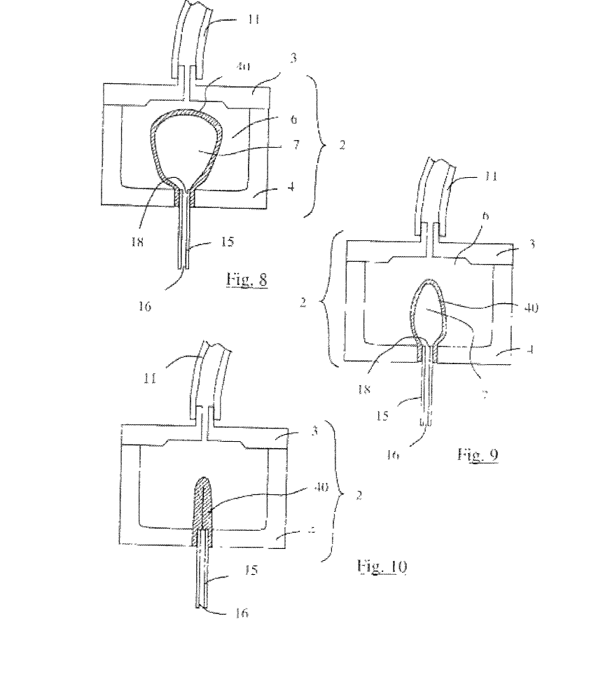

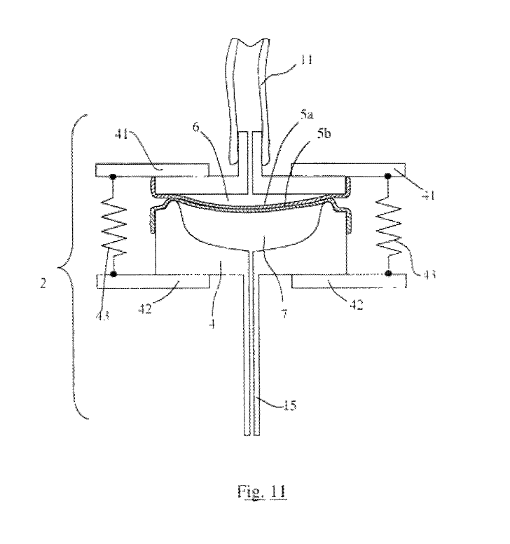

FIG. 5 shows the dispenser with membrane 5 fully pressed against the inner part 3 of the dispenser 2. This corresponds to the dispenser 2 having aspirated the maximum amount of sample liquid. FIG. 7 shows the dispenser with the membrane fully pressed against the nozzle mounting part 4 of the dispenser. This position corresponds to the sample liquid being fully expelled from the dispenser 2. FIG. 6 corresponds to an intermediate position of the membrane 5. It is important to appreciate that the membrane can move from the position shown in FIG. 5 to the one shown in FIG. 7 in a number of steps. For example the total volume of the main bore, i.e. the aggregate of the system liquid reservoir 6 and the sample liquid reservoir 7 could be of the order of 2 microliters and could be ejected in e.g. 100 steps making each dispensation equal to 20 nanoliters. It could also be ejected in one step.

Referring to FIGS. 8 to 10 inclusive, there is illustrated an alternative construction of dispenser, again indicated generally by the reference numeral 2. Parts similar to those described with reference to previous drawings are identified by the same reference numerals. In this embodiment, the divider barrier is formed from a separate sample liquid container in the form of an expandable bag 40.

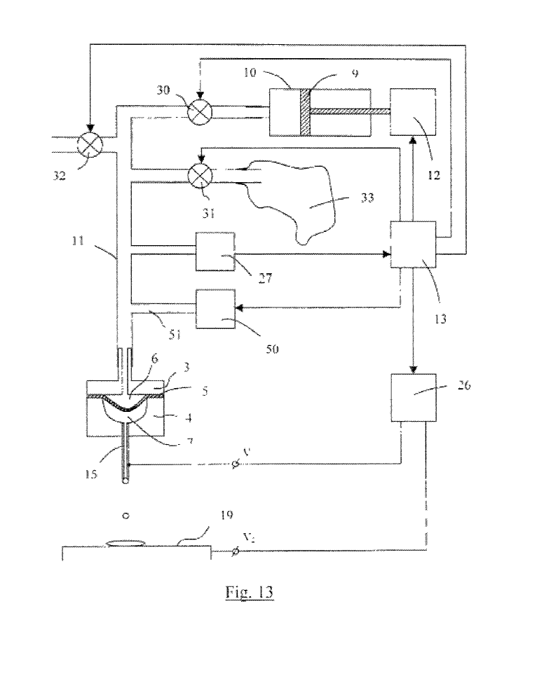

The expandable bag 40 separates the system liquid reservoir 6 from the sample liquid reservoir 7. FIG. 8 shows the expandable bag 40 in an almost fully expanded position. FIG. 10 shows it in the fully compressed position when essentially all the sample liquid is being expelled. FIG. 9 shows the expandable bag in an intermediate position. The only sample liquid remaining in the dispenser shown in FIG. 10 is the liquid in the nozzle 15. To avoid cross contamination through the liquid remaining in the nozzle 15, the dispenser 2 can aspirate and eject a washing liquid. In this case the sample liquid remaining in the nozzle 15 will be diluted/washed out. If necessary, this procedure can be repeated several times before the dispenser is filled up with a new sample liquid. It can be advantageous to make the expandable bag of an elastomer with a significant range of elasticity. This would allow reducing the dead volume in the dispenser left inside the expandable bag at the end of the dispensation. In this particular embodiment the inner part 3 and the nozzle mounting part 4 are held together by a suitable bonding agent.

Referring to FIG. 11, there is illustrated an alternative construction of dispenser, again identified by the reference numeral 2 and parts similar to those described with reference to the previous drawings are identified by the same reference numerals. In this embodiment, the divider barrier comprises two closely contacting members, in this case, two membranes 5a and 5b. The membrane 5a is bonded to the inner part 3 by a suitable adhesive and the membrane 5b is connected again to the nozzle mounting part 4 by adhesive. There is further provided means for releasably securing the inner part 3 to the nozzle mounting part 4 comprising a pair of clamping plates, namely, an upper clamping plate 41 and a lower clamping plate 42 connected together by springs 43.

When changing from one sample liquid to another one, the nozzle mounting part 4 along with the membrane 5b that has been in contact with the sample liquid can be exchanged to avoid cross contamination. The inner part 3 along with the membrane 5b does not come in direct contact with the sample liquid at all. This embodiment makes effectively the dispenser a disposable element and removes the need to wash it when the sample liquid is exchanged. Essentially the disposable element is the nozzle mounting part of the dispenser. One could also design other arrangements employing more than two membranes.

It should be appreciated that for the embodiment with two or more membranes to function correctly, there should be no air/gas trapped in between the membranes. Therefore, the assembly of the dispenser and exchange of the disposable part 2 of the dispenser should be performed in such a manner as to avoid trapping the air bubble. A number of routines could be used to achieve this result. For example, just before the moment the two parts 3 and 4 are finally tightly clamped and a small gap is left between them, the syringe pump could advance and press membrane 5a tightly against the membrane 5b. This expels any air trapped in between the two membranes. Then the parts 3 and 4 of the dispenser are finally clamped with syringe pump in the same position. Other solutions can also be proposed to include pumping any air left from the area in between the two membranes. In FIG. 11 the two springs are only shown schematically not to complicate the figure and focus on the essential aspects.

Referring now to FIG. 12, there is illustrated a dispensing assembly, again indicated generally by the reference numeral 1, substantially similar to the dispensing assembly illustrated in FIG. 4 and thus parts similar to those described with reference to FIG. 4 are identified by the same reference numerals. In this embodiment, the receiving electrode has a hole for the passage of a droplet therethrough, this receiving electrode being formed by a metal ring 45. Equally it could be a conducting plate with a hole or have another suitable geometry. The receiving electrode 45 is connected to the high voltage source 26. In this particular embodiment the nozzle 15 is connected to the ground potential. Strong electrostatic field is generated between the tip 16 of the nozzle 15 and the receiving electrode 45. This field pulls off the droplet from the tip 16 of the nozzle 15.

Referring now to FIG. 13, there is shown a still further construction of dispensing assembly, again indicated generally by the reference numeral 1, which dispensing assembly is substantially similar to the dispensing assembly illustrated in FIG. 4 and parts similar to those described with reference to FIG. 4 are identified by the same reference numerals. In this embodiment, there is provided a compression wave generator 50 connected to the controller 13 and to the tubing 11 and hence the system liquid reservoir 6 through further tubing 51.

A compression wave generator is a device that can excite a wave in the system liquid and/or sample liquid that reaches the tip of the dispenser. The wave causes the drop suspended at the tip to detach from the dispenser 2. Therefore, the operation of the dispenser 2 is as follows. Required volume of the sample liquid is expelled from the dispenser by advancing the plunger of the syringe pump 10. Then the compression wave generator 50 is actuated by the controller 13 and the drop is separated from the tip 16. In this embodiment the electrostatic drop off does not necessarily need to be used. However, incorporation of the electrostatic receiving electrode can still be advantageous even though the electrostatic field is not used for the droplet detachment. It could still be advantageous to apply a certain electrostatic field at the tip of the dispenser as this could be used to independently monitor the droplet separation from the tip e.g. by using Faraday pail. As the charge carried by the drop is related to its volume for a given value of the electrostatic field at the tip, measurement of the volume of dispensation can be performed. In addition, with the assistance of the electrostatic field, droplet separation using the compression wave generator is made more robust.

By using electrostatic drop-off means, it is possible to provide an electrostatic field that would not necessarily by strong enough to cause the droplet to detach from the dispensing tip 16 but would, to a significant extent, compensate for the attraction of the droplet to the dispensing tip 16 caused by the liquid surface tension. As a result, a compression wave of smaller amplitude may be sufficient to separate the droplet from the dispensing tip 16.

Referring to FIG. 14, there is illustrated a compression wave generator using a piezoactuator. In this embodiment, a piezoactuator, indicated generally by the reference numeral 52, which piezoactuator 52 comprises a piezo tube 53 rigidly connected to a pair of flanges 54 and 55. The piezo tube 53 mounts an inner tubular electrode 56 and an outer tubular electrode 57, electrically connected to a voltage pulse generator 58 which is in turn connected to the controller 13, for example, as illustrated in FIG. 13. The tube 51 comprises an expandable section in the form of a bellows 59 connected to the tube 51. The tube 51 is connected rigidly to the flange 54 at 60 and the bellows 59 is connected by a mechanical link 61 to the flange 55. The portion of the tube 51 connected to the flange 54 is of a rigid material, for example, a thin walled metal tube. Typically the bellows 59 is of the same material.

In this particular embodiment the piezoactuator is based on a piezo tube. The tube could be made of materials such as that of the PZT family. Materials of this family are known to those skilled in the art of piezomaterials. They are manufactured by a number of companies under a range of brand names. For example, Steveley Sensors Inc., 91 Prestige Park Circle, East Hartford, Conn. 06108, manufactures them under trade names such as EBL2 and EBL3. They are also manufactured by companies such as Ferroperm A/S, Piezoceramic Division, Hejreskovvej 6, DK-3490, Kvistgard, Denmark or Sensor Technology Ltd, PO Box 97, 20 Steward Rd, Collingwood, Ontario, Canada L9Y 3Z4 or Morgan Matroc Ltd, Unilator Division, Vauxhall Ind. Est., Ruabon, Wrexham, LL14 6HY, UK. The thickness of the tube wall is some 0.3 to 0.8 mm. Its length is some 8 to 50 mm and diameter is 3 to 20 mm. Specific compression wave generators with values of wall thickness, length and diameter outside this range can also be readily designed. The tube is polarized radially. Other designs of compressible sections not in the form of a conventional bellows could be readily proposed by those skilled in the art of mechanical design. When a voltage is applied between the inner electrode 56 and outer electrode 57, the thickness of the piezo tube 53 changes. Therefore length of the radially polarized tube changes as well along with the distance between the flanges 54 and 55. The voltage pulse generator 56 is capable of generating a voltage pulse with the amplitude of some 100 to 500 V and the duration of 10 microseconds. By applying this pulse to the inner and outer electrodes, one therefore excites a wave in the system liquid. When choosing the amplitude of the voltage pulse applied to the inner electrode 56 and the outer electrode 57, one has to be careful not to exceed the maximum allowed value of the electric field that can depolarize the piezo tube 53. This depends mainly on the material of the tube, and its thickness and also some other parameters such as e.g. temperature of the tube. Typical values for the depoling electric field are in the range of 300 to 600 V/mm.

The volume expelled from the compression wave generator as a result of the piezo tube 53's contraction is proportional to the voltage applied to the piezo tube 53 from the voltage pulse generator, length of the piezo tube 53 and cross sectional area of the bellows 59. This volume can be very small by comparison with the volume of the drop to be dispensed and still the compression wave generator could function correctly. Having the timing of the piezo tube 53's contraction short is as important as increasing the amplitude of contraction. A piezo tube 53 with a length of some 10 mm typically contacts by up to some 5 micrometers. If the cross sectional area of the bellows 59 is some 5 mm², then the volume expelled by the compression wave generator is only up to some 25 nanoliters. This presumes the tubing 11 is unexpandable. When choosing parameters of the compression wave generator, one should take into account expandability of the tubing joining the compression wave generator with the dispenser. In practice when the compression wave is launched, the tubing 11 will expand to a certain extent and dampen the compression wave. The required amplitude of the compression wave also depends on the parameters such as surface tension of the liquid dispensed and diameter of the nozzle 15. In addition it depends on the distance between the compression wave generator and the tip. In general the longer this distance, the more significant is the damping of the compression wave by the time is reaches the tip 16. Calculating the exact amplitude of the compression wave is therefore unpractical or impossible. A practical way of choosing the amplitude of the compression wave is as follows. The voltage generated by the voltage pulse generator 58 is gradually increased launching waves of progressively increasing amplitudes. The duration of the pulse generated by the voltage pulse generator is kept as short as possible. For example, one could generate pulses with the duration of 1 microsecond and the amplitude of 20, 40, 60, 80 and so on Volt. One should simultaneously monitor if the drop separation has occurred. There is a critical voltage required for the drop separation that depends on a number of parameters of the dispenser as described above. One should set up the amplitude of the voltage pulse generator above the critical values for all the liquids to be handled by the dispenser. If the maximum voltage that can be applied to the piezo tube is still insufficient to cause the drop off, the length of the piezo tube or the cross sectional area of the bellows should be increased.

FIG. 15 shows an example of schematics of a circuit of a voltage pulse generator. The circuit can energise the compression wave generator. It can generate voltage pulses with an amplitude of over 200 V and a duration of the pulse of some 10⁻⁵ seconds. The circuit is supplied with the control voltage pulse to the input of the amplifier U1. This voltage pulse is transformed and amplified by the circuit and supplied through the resistor R8 to the piezo transducer.

Referring to FIG. 16, there is illustrated an alternative construction of compression wave generator, again a further form of piezo actuator 65. Parts similar to those described with reference to FIG. 14 are used to identify the same parts. In this embodiment, the tube 51 is of a rigid material between at least the flanges 54 and 55 to which it is securely connected. The tube 51 is rigidly connected, as before, at 60 to the flange 54 and mounts on its other end, a compression wave membrane 66 of an elastic material such as a thin metal foil which in turn is connected by a bar 67 to the flange 55. The piezo tube 53 is connected to an intermediate tube support 68 in the form of a heavy ring which is in turn connected by a spring 69 to the flange 54. The spring 69 loads the flange 55 against the compression wave membrane 66.

The compression wave membrane 66 could be a thin metal foil, with a thickness of some 20 micron or greater bonded to the end of the system liquid tube. To increase the range of elasticity of the membrane, it could be advantageous to increase the diameter of the system liquid tube to over 10 mm. This would clearly require increasing the inner diameter of the piezo tube.

Increasing the mass of the piezo tube support 68 can be advantageous as explained below. If the length of the piezo tube 53 is decreased slowly as a result of a slow voltage ramp applied to the tube, this piezo tube's length reduction will be absorbed by extension of the spring's length and therefore will not be fully transferred into the compression wave membrane. However, if the contraction of the piezo tube happens very rapidly caused by a short voltage pulse applied to the piezo tube, the situation in different. In this case, most of the piezo tube's length contraction will be absorbed by the compression wave membrane provided the mass of the piezo tube 53 and the piezo tube support 68 is considerably greater than the mass of the flange 55 and the mechanical link 67. This result is then based on inertia. The inertia can be a major player during extension/contraction of the piezo tube caused by a short voltage pulse. Indeed although the compression of the piezo tube is relatively small and is typically in range of 10⁻⁶ to 10⁻⁵ m for the tube of some 10 mm length, the shortness of the time during which the extension takes place (10⁻⁷ to 10⁻⁵ sec) results in a significant acceleration in the range 10⁴ to 10⁹ m/sec². Therefore, by using action of inertia, one can achieve the situation whereby the compression wave membrane is preloaded against the flange 55 by means of a relatively soft spring with significant range of elasticity. Yet, this softness of the spring is not an obstacle during the rapid compression or expansion of the piezo tube caused by the voltage pulse applied to it in a sense that compression or expansion of the piezo tube is not absorbed by the spring. The bar 67 is a bar with a diameter of some 1 to 2 mm mechanically coupling the centres of a compression wave membrane 66 and the flange 55. The intermediate tube support 68 has two functions. The first is to facilitate the bonding of the spring 69 to the piezo tube 53 as bonding of the spring material with brittle piezo material can be complicated. The second is that the intermediate tube support 68 increases the mass of the assembly attached to the spring 69 and therefore enables the use of inertia for launching of the compression wave as explained above.

Referring to FIG. 17, there is illustrated another compression wave generator, in this case, a magnetostrictive actuator, indicated generally by the reference numeral 70. Parts similar to those described with reference to FIG. 14 are identified by the same reference numerals. In this embodiment, instead of a piezo tube, there is provided a plurality of four pillars 71 of magnetostrictive material connecting the flanges 54 and 55 together. Each pillar is surrounded by a coil 72.

The diameter of the pillars 71 is some 1 to 5 mm and their length is some 10 to 30 mm. Embodiments of compression wave generators with magnetostrictive elements having dimensions outside this range could be also designed. The voltage pulse generator 58 can generate a current pulse and therefore the pulse of magnetic field. As a result, the length of the magnetostrictive pillars 71 will change moving the flange 55 and therefore coupling the compression wave into the system liquid through the mechanical link 61. There is a pre-stress spring 62 that applies mechanical load across the magnetostrictive pillars. The optional pre-stress spring can help to improve the performance of the magnetostrictive actuator.

Numerous other designs employing a magnetostrictive element or elements could be readily proposed. For example, one could use a single cylindrical magnetostrictive element in the shape of a cylinder instead of a number of pillars. It is not necessary to use separate magnetic field coil for each of the pillars. One could generate a field around all of the pillars using a single coil. Suitable magnetostrictive materials can be found in handbooks on magnetic materials. For example, materials such as Nickel or certain types of permalloy can be employed. These are specially d3eveloped materials with high magnetostriction constants such as, e.g. TbₓDy_{y}Fe_{z} alloys called Terfenol that could also be employed. These materials are commonly known to designers of magnetic actuators.

The disadvantage of magnetostrictive actuators compared to the ones using piezomaterials is that they do not perform as well at high frequencies, e.g. above 100 kHz. On the other hand they can deliver greater amplitude of displacement, e.g. greater amplitude of the compression wave. To improve the performance of the magnetostrictive actuator at high frequency one could use special materials with low conductivity e.g. Terfenol particles embedded in a non-conducting matrix or special laminated materials.

Two additional points should be kept in mind by a designer of the compression wave generator using a magnetostrictive actuator.

1. It may be beneficial to create a bias DC magnetic field and then superimpose the pulse of magnetic field onto the bias DC magnetic field. If the bias magnetic field is chosen correctly, greater amplitude of the compression wave could be achieved for the same amplitude value of the magnetic value of the magnetic field pulse. This is explained in detail in e.g. Advances in Actuators by A. P. Dorey, J. H. Moore, Institute of Physics Publishing, 1995, ISBN: 0750302917, Chapter 8. This DC bias magnetic field could be generated by a DC current supplied to the coils 1, 2, 3 and 4. For example, the DC field could be generated by driving current of 1 Amp through the coils 1, 2, 3, 4 and the pulse of magnetic field could be created by a current pulse with the amplitude of some 0.5 Amp superimposed on it. In this case an electronic circuit of the current pulse generator should be designed in such a way as to be capable of supplying a current pulse against background of the DC current both being fed into the same load. Circuits of this kind can be readily designed by those skilled in the art of electronics. Other solutions for the creation of the DC offset field can be readily proposed.

2. The sign of the compression depends on the direction of the magnetic field with regard to the orientation of the grains in the magnetostrictive material. Therefore, not only the shape of the magnetostrictive pillars matters but also the microgram structure direction is important. If the extension of the magnetostrictive pillars is achieved instead of desired contraction, then this could be easily corrected e.g. by reversing the sign of the current pulse. For example, pulse with the amplitude of −0.5 Amp could be superimposed on the DC current instead of the +0.5 Amp pulse. Alternatively, the mechanical link and the coupling to the system liquid tube could be changed to benefit from the extension of the magnetostrictive pillars and not their contraction.

Referring to FIG. 18, there is illustrated an alternative construction of magnetostrictive actuator, indicated generally by the reference numeral 75. Parts similar to those described with reference to FIGS. 16 and 17 are identified by the same reference numerals operation of this embodiment of compression wave generator is self-explanatory on the basis on the description related to FIGS. 16 and 17.

Referring to FIG. 19, there is illustrated an alternative construction of compression wave generator, in this case, a magnetostatic actuator, indicated generally by the reference numeral 80. Parts similar to those described with reference to FIG. 18 are identified by the same reference numerals. In this embodiment, the flanges 54 and 55 are mounted between two opposed sets of magnetic actuators, indicated generally by the reference numerals 81 and 82. The magnetic actuator 81 comprises two half coils 81a and 81b connected together by springs 83 and surrounded by two sets of coils 84 and 85. The magnetic actuator 82 also has two sets of coils 86 and 87. The coils 84, 85, 86 and 87 are all connected to the pulse generator 58.

As the coils 84, 85, 86 and 87 are energized with a magnetic field by means of a current pulse generator 58, there will be attractive force acting between the two parts of the magnetic cores. This force will push the flange 55 towards the compression wave membrane 66 and will excite the compression wave in the system liquid. The coils 84 and 85 will excite magnetic field that is opposite to each other as indicated by arrows. The same applies to the coils 86 and 87. In this way they excite continuous magnetic flux throughout each of the two magnetic cores 81a, 81b and 82a, 82b. It may be beneficial to use the core of magnetic material having high magnetic permeability at high frequency. The reason is that the short current pulse in the coils has high-frequency components in the spectrum. Therefore, to increase the force of attraction of the two parts of magnetic core, it may be advantageous to use a core with high magnetic permeability at high frequency, particularly in the case when the coil can be energised within a very short time. This time is determined primarily by the inductance and resistance of the coil and by the current pulse generator. Suitable materials can be found in numerous product data books. For example, material such as manganese zinc ferrite type 77 or 78 sold by Fair-Rite Products Corp, is a suitable option. Similar soft ferrites are manufactured by a number of other companies.

Referring to FIGS. 20 and 21, there is illustrated an alternative construction of dispenser, again identified by the reference numeral 2, in which parts similar to those described with reference to the previous drawings are identified by the same reference numerals. In this embodiment, the inner part 3 comprises a bimorph piezo consisting of layers 3a and 3b of piezo material connected to the voltage pulse generator 58. In this bimorph piezo, the piezo layers 3a and 3b are polarized in such a way that when one of the layers extends, the other one contracts. There are three electrodes 90, 91 and 92 incorporated in the bimorph piezo. The electrodes are in turn connected to the voltage pulse generator 58. For example, suppose the upper layer 3a extends and the lower layer 3b contracts. In this case the central area of the inner part 3 of the dispenser bends 2 towards the membrane 5 as shown in FIG. 21. If this is done rapidly as a result of a voltage pulse applied to the piezo bimorph, the compression wave is excited in the dispenser 2. The bending mode of mechanical oscillations usually has a lower resonance frequency than the thickness mode. Therefore, even if the voltage pulse generator sends a very short voltage pulse to the piezo layers, the bimorph may not be able to respond by a rapid deformation if its own resonance frequency is too low. By increasing the thickness of the bimorph or by decreasing its length, one can increase the resonance frequency of the compression waver generator.

The shape of the piezo bimorph under the bending deformations can be calculated using the standard formulas for the mechanics of deformations readily available in the literature. The piezo bimorph can consist of the same material PZT as described above. The thickness of the layers depends on the size of the dispenser that is in turn determined by the required volume of the sample liquid reservoir. For a sample liquid reservoir with the diameter of some 5 mm, the thickness of the piezo layers in the range of 0.2 to 0.6 mm was found to be acceptable. The thicker the individual layers of the bimorph, the smaller is the bending deformation. Therefore, when thicker layers are used, a voltage pulse of greater amplitude should be applied to the bimorph to excite the wave of the same amplitude. On the other hand using thicker piezo bimorph has advantage in that the resonance frequency of the bimorph increases making excitation of a faster compression wave possible.

It should be noted that the deformation of the bimorph is shown greatly exaggerated in FIG. 21 for ease of understanding.

Referring to FIG. 22, there is illustrated how a piezoactuator, similar to the piezoactuator 52 and thus identified by the same reference numerals, used in the embodiment of FIG. 14, can be mounted on the dispenser and in this embodiment, is coupled with the nozzle 15. Again, parts similar to those described with reference to the previous drawings are identified by the same reference numerals. In this embodiment the compression wave generator based on a piezo tube is coupled to the nozzle. It can be advantageous to make the nozzle of a capillary with a very thin wall to enable its easier extension/contraction by means of the compression wave generator. The piezo tube 53 is bonded between flanges 54 and 55. The two flanges 54 and 55 are in turn bonded to the nozzle 15. The piezo tube 53 is polarized radially in the same way as in the embodiment of FIG. 14. The length of the tube is some 5 to 30 mm and its inner diameter is some 1 mm or greater. The wall thickness of the tube is some 0.3 to 1 mm. Compression wave generators using tubes with sizes outside this range can also be readily designed. The material of the piezo tube can be identical to the one described in earlier embodiments. There are two conducting electrodes on the piezo tube 53: namely an inner electrode 56 and an outer electrode 57. When the voltage is applied between the two electrodes, the thickness of the piezo tube is changed. Therefore its length also changes and this moves the flange 54 with respect to the flange 55.

Referring to FIG. 23, there is illustrated the use of the magnetostrictive actuator such as the magnetostrictive actuator 70, illustrated in FIG. 17 and again identified by the same reference numeral in this drawing, can be used when coupled to the nozzle 15 of the dispenser, again identified by the reference numeral 2. Again, parts similar to those described with reference to FIG. 17 are identified by the same reference numerals. In this embodiment, only one coil 95 is used and instead of a plurality of pillars 71, a cylinder 96 of magnetostrictive material is used which is then bonded between the flanges 54 and 55.The magnetostrictive material is similar to the one used some previous embodiments. The outer diameter of the cylinder 96 could be in the range of some 1 to 5 mm. The length of the cylinder 96 could be in the range of some 10 to 30 mm. The cylinder of the magnetostrictive material is placed inside the coil 95 which again is connected to the current pulse generator 58. In use, a short current pulse in the coil 95 generates the pulse of magnetic field at the cylinder 96 of magnetostrictive material and causes the compression of the cylinder 96. The nozzle 15 is also rapidly compressed thus enabling the separation of the drop from the tip of the nozzle.

In the embodiments of FIGS. 22 and 23, the care should be taken to reduce the mass of the flanges 1 and 2. Increasing their mass increases inertia of the compression wave generator and decreases the amplitude of the wave.

Referring to FIG. 24, there is illustrated a dispensing assembly, again indicated generally by the reference numeral 1, substantially similar to the dispensing assembly illustrated in FIG. 4. In this dispensing assembly, there is provided additional tubing 97 feeding the tubing 11 to a high-speed valve 98 connected to the controller 13. The high-speed valve is connected to a pressure source, namely a gas compressor 99 feeding through a line 100, the high-speed valve 98. System liquid and compressed gas is contained in the line 100 forming an interface 101. The compressor 99 is capable of producing positive pressures in the range of up to 10 to 20 bar. Operation of this dispensing assembly is as follows. Suppose, the system liquid continuously fills up the line joining the high-speed valve with the tubing and also the high-speed valve itself. In this case the level of system liquid is above the high-speed valve as shown in FIG. 24. Suppose, the high-speed valve 98 is closed and pressure in the line 100 above the high-speed valve, i.e. in the section of the line joining the high-speed valve with the pressure source, is equal to P_{eject} that is above the atmospheric pressure. Suppose the sample liquid is aspirated into the sample liquid reservoir 7 by the syringe pump 10 as described above. The volume of the sample liquid aspirated is defined by the displacement of the syringe pump 10. To eject the entire volume of the sample liquid from the sample liquid reservoir 7, the high-speed valve 98 is opened. Pressure in the system liquid reservoir 6 will rise rapidly and as a result the membrane 5 will be deformed to eject all the sample liquid from the sample liquid reservoir 7. The optimal pressure P_{eject} depends on the specific dimensions of the dispenser. Primarily it depends on the length and the diameter of the nozzle 15. The greater the length and the smaller is the diameter, the greater is the pressure required to ensure that the sample liquid expelled from the sample liquid reservoir gets detached from the tip 16. On the other hand the pressure should not be too great to avoid damage to the membrane 5 and also for the reason that some biological liquids should not be subjected to an excessive pressure. We have found that the pressure in the range of up to 5 Bar is often adequate for the dispensation in the range of the order of 10 nl. In some cases, especially when dispensing liquids with higher viscosity such as e.g. glycerol, greater pressure in the range of 10 to 30 Bar can be preferable. Once the membrane is pressed against part 2 of the dispenser and all the sample liquid is ejected, the membrane will not stretch any further into the entrance provided the pressure P_{eject} is not too high. At this moment the dispensation is completed and the high-speed valve can be closed. It will be appreciated that pressure sources other than compressors may be used such as, for example, bottles of compressed gas or the like.

Referring to FIG. 25, there is illustrated an alternative construction of dispensing assembly, again indicated generally by the reference numeral 1, which is substantially similar to the dispensing assembly illustrated in FIG. 24 and thus parts similar to those described with reference to FIG. 24 are identified by the same reference numerals. In this embodiment, there is provided a valve 102 in the line 100 between the compressor 99 and the high-speed valve 98. A further pressure release valve 103 is provided. A liquid level detector comprising a laser diode 104 and a photodiode 105 is also provided. A photodiode is connected to the controller 13.

The laser diode 105 focuses a laser beam on the line 100, and the photodiode 104 receives the light that has passed through the control line 100. As the level of liquid 101 passes through the focused laser beam, the signal received by the photodiode 104 changes. The photodiode and the laser diode are connected to their respective control circuits that are not shown in FIG. 25. Those skilled in the art can readily propose numerous other means for control of level of system liquid including in the control line optical and non-optical means. Those skilled in the art can further appreciate that if optical means of the level control are employed then the control line should be preferably optically transparent. They can further appreciate that to improve signal to noise ratio and therefore accuracy of the monitoring of the level of liquid it may be advantageous to modulate light emitted by the laser diode. This would allow using a phase-sensitive detector (lock-in amplifier) or narrow-band amplifier to measure signal from the photodiode. It can be further proposed that the system liquid is dyed with an ink to improve sensitivity of monitoring of the level of liquid.

The dispensing assembly operates as follows. The level of liquid in the control line 100 is maintained constant at certain stages of the aspirate-dispense cycle. All the walls of the control line 100 and tubing 97 joining the high-speed valve 98 and the tubing 11 are non-expandable. If one considers that the liquid up to the height of the level of liquid in the control line also forms a part of the system liquid reservoir, then it is clear that all the above analysis of the dispensing assembly applies here. Suppose, the high-speed valve 98 is closed and the syringe pump 10 has its plunger 9 pulled back by the volume Vₐₛₚ to aspirate system liquid. Suppose the level of liquid 101 in the control line 100 is equal to l₀. To dispense the system liquid, first the valve 103 and the high-speed valve 98 are kept closed. Valve 102 is open. Then the control line 100 is pressurised. This does not change the level l₀ as the control line is non-expandable. When the high-speed valve 98 is open, the sample liquid is expelled from the dispenser 2 as explained with reference to FIG. 24. The aspirate phase starts with the routine to bring up the level of the system liquid in the control line 100 to the same height l₀. To achieve this, the valve 102 closes and the high-speed valve 98 opens. The valve 103 is opened preferably in short intervals or pulses so that the level of liquid in the control line becomes equal to the same value l₀. The liquid in the control line 100 is pushed upwards as the membrane 5 contracts. Then the high-speed control valve 98 is closed, the syringe plunger 9 is moved forward to expel the volume Vₐₛₚ it has aspirated in the previous aspiration cycle and therefore all the elements in the dispensing assembly have returned to their initial position and the dispensing assembly can again aspirate the sample liquid as described above.

Means for monitoring the level of system liquid in the control line 100 can also be used to eject fractions of the volume of sample liquid aspirated. In this case, the volume of the sample liquid ejected is determined by the duration of the time interval during which the high-speed valve 98 is open, the pressure in the control line 100, viscosity of the liquid and cross-sectional area of the nozzle 15 and tubing 11. The volume expelled is calculated as the height difference between the levels of the system liquid in the control line 100 before and after the ejection multiplied by the cross-sectional area of the control-line.

Referring to FIG. 26, there is illustrated an alternative construction of dispensing assembly, again indicated generally by the reference numeral 1, which dispensing assembly is substantially similar to the dispensing assembly illustrated in FIG. 24, except that instead there is interposed in the tubing 97, a valve 110 incorporating a membrane 111. In this way, instead of using the system liquid in conjunction with the dispensing assembly, a different system liquid may be used although it may be the same system liquid but is separated from the rest of the system liquid by the membrane 111. The dispensing assembly operates in substantially the same way as heretofore, the advantage being that there is no need to top up the control line 100.

Referring to FIG. 27, there is illustrated portion of another dispensing assembly according to the invention, substantially similar to the dispensing assembly illustrated in FIG. 2 and parts similar to those described with reference to FIG. 2, are identified by the same reference numerals. In this embodiment, the compression wave generator comprises a mechanical actuator, indicated generally by the reference numeral 115, comprising a lever arm 116 pivotally mounted intermediate its ends by a pivot pin 117 mounted on a fulcrum 118. The lever arm 116 carries a hammer head 119 through which the tubing 11 projects. A stop 120 is mounted above the lever arm 116. The end of the lever arm 116 opposite the hammer head 119 carries a soft magnetic core 121 housed within coil 122 driven by the current pulse generator 58. A return spring 123 is also provided. If the coil 122 is energised by a current pulse, there is a force pulling the soft magnetic core 121 into the coil. As a result, the hammer head 119 accelerates and hits the inner part 3 of the dispenser 2 thus exciting a compression wave. In the absence of the current in the coil 122, the hammer rests against the stop 120. The amplitude of the movement of the hammer head 119, under the influence of the spring 123, depends on the specific design of hammer head and the magnetic actuator formed by the core 121 and coil 122. It may be advantageous to limit movement of the hammer in such a way that it cannot travel more than some 1 to 3 mm between the two positions, namely, with the hammer head 119 resting on the inner part 3 of the dispenser 2 and with the hammer head resting against the stop 120. In use, it is important not to shorten the duration of the current pulse applied to the coil 122. In fact the pulse could re relatively long to cause significant acceleration of the hammer head 119.

Referring to FIG. 28, there is illustrated another construction of dispenser, again indicated generally by the reference numeral 2, in which parts similar to those described with reference to the previous drawings are identified by the same reference numerals. In this embodiment, there is provided a compression wave generator, namely, a magnetic actuator, indicated generally by the reference numeral 125. The magnetic actuator 125 comprises a two part core, namely, an upper part 126 and a lower part 127 connected together by a hinge joint 128. The lower part 127 is mounted on the inner part 3 of the dispenser 2. The upper part 126 is urged away from the lower part 127 by a compression spring 129. A coil 130 is mounted around the upper part 126. The coil is again connected to the current pulse generator 58. The upper part 126 is separated from the lower part 127 by a gap of some several millimeters. When the coil 130 is energised by a current pulse, the two parts 126 AND 127 of the magnetic core attract each other and if the current is sufficiently strong, the core gap will close. Therefore, the lower part 127 will transmit a compression wave through the inner part 3.

Referring now to FIG. 29 there is illustrated a dispensing assembly indicated generally by the reference numeral 1 incorporating a dispenser 2 as described above. Parts similar to those described with reference to the previous drawings are identified by the same reference numerals. In this embodiment the droplets are identified by the numeral 140 and successive subscripts thus 140(a) to 140(c). The dispensing tip 16 effectively forms or incorporates an electrode by virtue of being grounded by an earth line 141. There is mounted below the dispenser 2 a receiving substrate 145 incorporating reagent wells 146 and successive subscripts a, b and c. For three of the wells 146 (a), (b) and (c) there are, for simplicity identified by the same subscript letters, droplets 140 (a), (b) and (c) both approaching the wells 146 and in them. Positioned below the receiving substrate 145 is a receiving electrode 147 in turn mounted on an indexing table 148. The receiving electrode 147 is connected to a high voltage source 149.

The indexing table 148 is used to position the receiving electrode 147 below the appropriate reagent well 146 as shown by the interrupted lines in the drawing. It should be noted that alternatively the nozzle 15 could be connected to the high voltage source 149 and the receiving electrode could be connected to the ground potential. Indeed other arrangements are possible resulting in electrostatic field between the dispensing tip 16 and the receiving electrode 147.

Referring now to FIG. 30 there is illustrated an alternative construction of dispensing assembly, in which parts similar to those described in FIG. 29 are identified by the same reference numerals. In this embodiment there is provided a plurality of receiving electrodes 150 on the indexing table 148, which are individually connected to the high voltage source 149.

Referring now to FIG. 31 there is illustrated still further construction of dispensing assembly 1 in which parts similar to those described with reference to FIG. 30 are identified by the same reference numerals. In this embodiment there are provided additional deflecting electrodes 155 and 156. It will be appreciated that depending on the voltage on the deflecting electrodes 155 and 156, the droplets 140 will in conjunction with the receiving electrodes 147 navigate into the appropriate reagent well 146. This is illustrated clearly in FIG. 31 by the interrupted lines. In FIG. 31 there is also shown a receiving electrode 147 but it will be appreciated that such a receiving electrode 147 will not always be necessary. It is also possible to use a conducting plate such as illustrated in FIG. 2 or it is possible to use only deflecting electrodes. However, what will be appreciated by consideration of the dispensing assemblies as illustrated in FIGS. 29 to 31 inclusive is that electrostatic navigation of the drops by means of both the receiving electrodes and the deflecting electrodes can be relatively easily achieved. For example, the receiving electrode could be in the form of a plate having at least one hole to allow a droplet pass therethrough.

With a further miniaturization of the substrate targets, it becomes increasingly difficult to ensure that the drop reaches the correct destination as it is ejected from a liquid handling system. For applications such as high-density arrays, the size between the subsequent drops covering the substrate, herein called pitch, could be as small as 0.1 mm. By analysing FIGS. 29, 30, 31 one can appreciate that in this invention there are two different means of controlling the destination of the drop, both are based on the electrostatic forces acting on the drop as it travels between the nozzle and the well.

The first way is to generate the electrostatic field with a small charged drop off or receiving electrode positioned underneath the well instead of a large conducting plate. The size of the electrode is smaller than the size of the well for accurate navigation. It may be advantageous as described above to have the receiving electrode in the shape of a tip to produce the strongest electric field at the centre of a destination well. The electrode produces a strong electric field underneath the well attracting the drop to the required destination position (usually the centre of the well). The receiving electrode may be attached to an arm of a positioner capable of moving it underneath the well plate and pointing to the correct destination well. Alternatively, the sample well plate may be repositioned above the receiving electrode in order to target a different well. It may be necessary to move the dispensing tip and receiving electrode synchronously. It may be advantageous to have a module with a number of receiving electrodes that could be connected to the high voltage supply independently. The distance between the electrodes could be the same as the distance between the centres of the wells in a well plate. In this case the drops could be navigated to different wells without actually moving the dispenser or the receiving electrode.

In an arrangement in FIG. 31, deflection electrodes are positioned along the path between the nozzle and the destination well. The electrodes are charged by means of a high voltage applied to them. As the drops leaving the dispensing tip are charged by the voltage between the dispensing tip and the receiving electrode, they will be deflected by the deflection electrodes.

It is important to realise that during the electrostatic drop off, the electrostatic force acting on the drop could much greater than the gravity force. In this case as the drop flies between the nozzle and the substrate, the direction of the path is determined by the direction of the electrostatic field.

The electrostatic field required to detach a droplet from the tip is a function of the volume of the suspended droplet on the dispensing tip. It becomes important to ascertain exactly when the droplet is released from the dispensing tip. Accordingly, the invention provides various methods of detection of the separation of a droplet from the dispensing tip. Once the electrostatic force causing the drop off to be achieved is known, then the volume of the droplet can be calculated within relatively fine limits. While in many instances, it is necessary to calibrate the dispenser for each new liquid because the field required for drop detachment depends on the properties of the liquid and of the nozzle, in certain instances this is not required.

Referring to FIG. 32, there is illustrated a detector indicated generally by the reference numeral 160, for sensing the separation of a droplet from the dispensing tip. Again, for illustrative purposes, the dispenser 2 is illustrated. The detector 160 comprises source 161 of electromagnetic radiation, a collector of electromagnetic radiation 162 and a controller 163 connected to the electromagnetic radiation source 161 and collector 162.

In this embodiment, the electromagnetic radiation source 161 is a laser. There is illustrated a laser beam 164 emanating from the electromagnetic radiation source 161 and then either being reflected by the suspended droplet as a further laser beam 165 to the electromagnetic collector 162 or as a beam 166 passing straight beyond the dispensing tip 16 when a droplet 155 is not in position. It will be appreciated that only a fraction of the laser beam 164 returns as the beam 165 to the electromagnetic radiation collector 162.

Alternatively, embodiments can be devised in which the electromagnetic radiation from the source 161 reaches the collector 162 as it is refracted by the droplet suspended at the tip. As the drop is removed from the tip, the amount of radiation reaching the collector 162 changes.

In other embodiments, the radiation from the source 161 reaches the collector 162 as it is absorbed by the drop, again resulting in the same effect of changing the intensity of radiation collected by the collector 162 caused by the drop detachment.

To describe all the three options for coupling the radiation between the source 161 and the collector 162 through the droplet, we will use the term “radiation transmitted” in this specification in respect of reflection, refraction and absorption.

In the present invention, the monitoring of the droplet in flight is envisaged by means of charge measuring devices such as Faraday cup. This is feasible as the drop pulled off from the dispensing tip by electrostatic field, will be charged. It is important in many instances to be absolutely certain that the droplet was actually dispensed and ideally also to ascertain the volume of the droplet and this has been described above.

Referring to FIG. 33, there is illustrated an alternative construction of dispensing assembly, again indicated generally by the reference numeral 1. The dispensing assembly is substantially similar to the dispensing assembly of FIG. 12 and thus parts similar to those described with reference to FIG. 12 are identified by the same reference numerals. The only difference between the two dispensing assemblies is that although the dispenser 2 comprises again, an inner part 3 and a nozzle mounting part 4, the nozzle mounting part 4 now mounts a plurality of nozzles 15 and the divider barrier which is again formed from the membrane 5 which additionally separates portion of the main bore adjacent each nozzle entrance to form separate sample liquid containing portions 7 divided from the one system liquid containing portion 6. Strictly speaking, it is not one dispenser but a plurality of dispensers 2, however, it is preferable to still identify them by the reference numeral 2 to avoid the use of subscript letters which would be confusing.

There are electrostatic receiving electrodes 45 positioned in the vicinity of the tips 16 of the nozzles 15. The drops are detached from the nozzles 15 by means of electrostatic field as these receiving electrodes 46 are connected to the high voltage source. The receiving electrodes are connected to the high voltage source 26 through a multiplexer unit 170 so that individual receiving electrodes can be connected to the high voltage source 26 separately if required to detach droplets from the selected nozzles 15.

FIG. 33 shows an embodiment of a dispensing assembly in which a number of different liquids can be aspirated and dispensed by means of single syringe pump 10. The most likely application of this device is simultaneous aspiration and dispensing of equal amounts of a number of liquids without intermixing. For example, it can be necessary to aspirate 48, 96, 384, 1536 or another number of liquids from a well plate and dispense these onto a target substrate or another well plate or a microchannel structure.

All the system liquid reservoirs of the dispenser 2 are hydraulically connected to the syringe pump 10. If all the membranes 5 in, what are effectively, separate dispensers, are identical, the volume of the system liquid expelled by the syringe pump will be divided equally between the individual dispensers. For example if the volume of the system liquid expelled by the syringe pump is 960 nl and there are 96 dispensers in the assembly, the volume of the sample liquid expelled from each of the dispensers is 10 nl. If the membranes are not identical, then the volume expelled from a dispenser with a softer, more elastic membrane is greater than the one expelled from a dispenser with a stiffer membrane. Individual control of the voltage for separate nozzles is necessary for individual control of the individual channels. For example, for some applications it may be necessary to dispense liquid from all even-numbered dispensers into one well plate and dispense liquid from all the odd-numbered dispensers into another well plate.

For detachment of droplets from the tips, the dispensing assembly can employ a compression wave generator or pressure source as described in above embodiments.

In order to have equal volumes of sample liquid expelled from the individual dispensers, it is advantageous to have the membranes substantially pre-stretched during the entire dispensing step. The reason is that even if the membranes are identical, the volume expelled by the syringe pump may not be equally divided between the dispensers if the membranes are loose. It is desirable that identical additional extension of the membranes results in identical pressure increase in the individual dispensers. It is therefore advantageous to operate the assembly at a considerable excess pressure above the atmospheric pressure. The simplest solution can be to ensure that during the aspiration, the membrane is not allowed to become flat and remains always considerably bent towards the nozzle mounting part of the dispenser.

One could readily design a dispenser in which the membranes at different dispensers are not identical. For example, one could design a dispenser in which the membranes on all the odd channels are twice as stiff as the ones of the even channels. This dispenser could be used for an application whereby it is necessary to dispense unequal amounts of liquids or dispense only liquids from some dispensers.

It is important to appreciate that a dispensing assembly in which individual dispensers are controlled by means of individual syringes, can also be designed. This can offer greater flexibility in the control of the individual dispensers that may be of benefit for certain applications.

Referring to FIG. 34, there is illustrated a dispensing assembly substantially identical to the dispensing assembly illustrated in FIG. 33. In this embodiment, there is a combined high voltage source and multiplexer 175 provided and there are no nozzles projecting from the dispenser 2. There is one electrode 174, essentially earthed, formed in what was previously the nozzle receiving part of the dispenser.

FIG. 35 shows another embodiment dispenser 2 in which instead of a membrane clamped between the inner part 3 and the nozzle mounting part 4, there are flexible elastometer containers 176 in the shape of bells separating the sample liquid reservoir 6 from the system liquid reservoir 7. The bells are compressed by the pressure in the system liquid reservoir 6 and expel sample liquid from the sample liquid reservoirs 7. Once again the principle of the dispensing assembly is based on the fact that although the bells are made of an elastic material and will deform considerably during the dispensation, the volume of the bells walls will remain substantially unchanged. The embodiment of FIG. 35 shows a composite dispenser with four nozzles. It is clear that dispensing assemblies with other numbers of individual dispensers can also be designed. The means for drop detachment from the end of the nozzles 15 are not shown. These could be similar to any of the means described above.

Referring to FIG. 36, there is illustrated an alternative construction of dispensing assembly, again indicated generally by the reference numeral 1, substantially identical to the dispensing assembly illustrated in FIG. 13, except that instead of one syringe pump 10, there is a syringe pump 10a and a syringe pump 10b, together with associated motors 12a and 12b. The pump 10b is a small volume pump and is used for accurate dispensing of small volumes. The pump 10a is a larger volume pump. The pumps are mounted in parallel.

This arrangement is used to achieve a large dynamic range. The two pumps 10a and 10b installed in parallel can operate in a co-ordinated manner to achieve both a large dynamic range and high precision for dispensing small volumes.

Generally, the pumps 10a and 10b which will be positive displacement pumps such as syringe pumps, will be so constructed that one pump will have a working stroke displacing a volume, at least about ten times larger than that of the other pump. Indeed, in many instances, the difference in displacing a volume from one stroke of the larger pump will be twenty or more times greater than the displacement of the smaller pump.

In the specification the terms “comprise, comprises, comprised and comprising” or any variation thereof and the terms “include, includes, included and including” or any variation thereof are considered to be totally interchangeable and they should all be afforded the widest possible interpretation and vice versa.

The invention is not limited to the embodiment hereinbefore described, but may be varied in both construction and detail within the scope of the claims.

1. A dispensing assembly for sample liquid droplets of less than 5 μl in volume comprising:
a dispenser body having a main bore;
a nozzle mounted on the dispenser body and terminating in a dispensing tip, the nozzle having a nozzle bore with a nozzle entrance communicating with the main bore;
a divider barrier for separating system and sample liquid within the assembly, the divider barrier comprising a body of elastomeric substantially incompressible material; and
a positive displacement pump for delivery of metered quantities of system liquid through the assembly to displace the barrier to deliver sample liquid through the nozzle bore.

2. A dispensing assembly as claimed in claim 1 comprising;
an electrode electrically coupled to the dispensing tip;
a separate receiving electrode remote from the tip; and
a high voltage generating means connected to at least one of the electrodes to provide an electrostatic field therebetween.

3. A dispensing assembly as claimed in claim 1 comprising;
an electrode electrically coupled to the dispensing tip;
a separate receiving electrode positioned below the tip; and
a high voltage generating means connected to at least one of the electrodes to provide an electrostatic field therebetween.

4. A dispensing assembly as claimed in claim 1 comprising:
an electrode electrically coupled to the dispensing tip;
a separate receiving electrode remote from the tip;
a high voltage generating means connected to at least one of the electrodes to provide an electrostatic field therebetween; and
a droplet receiving substrate mounted between the receiving electrode and the dispensing tip.

5. A dispensing assembly as claimed in claim 1 comprising;
an electrode electrically coupled to the dispensing tip;
a separate receiving electrode remote from the tip including a hole for the passage of a droplet therethrough;
a droplet receiving substrate mounted below the receiving electrode; and
a high voltage generating means connected to at least one of the electrodes to provide an electrostatic field therebetween.

6. A dispensing assembly as claimed in claim 1 comprising;
an electrode electrically coupled to the dispensing tip;
a plurality of separate receiving electrodes remote from the tip each having a hole for the passage of a droplet therethrough;
a droplet receiving substrate mounted below the receiving electrodes;
means for activating the receiving electrodes separately; and
a high voltage generating means connected to at least one of the electrodes to provide an electrostatic field therebetween.

7. A dispensing assembly as claimed in claim 1 comprising;
an electrode electrically coupled to the dispensing tip;
a separate receiving electrode remote from the tip;
a droplet receiving substrate mounted above the receiving electrode;
a high voltage generating means connected to at least one of the electrodes to provide an electrostatic field therebetween; and
synchronous indexing means for the dispenser and the receiving electrode for accurate deployment of droplets on the substrate.

8. A dispensing assembly as claimed in claim 1 comprising;
an electrode electrically coupled to the dispensing tip;
a plurality of separate receiving electrodes forming droplet deflection electrodes remote from the tip;
a droplet receiving substrate mounted above the deflection electrodes;
a high voltage generating means connected to at least one of the deflection electrodes to provide an electrostatic field between them and the tip; and
control means to vary the voltage applied to the deflection electrodes.

9. A dispensing assembly as claimed in claim 1, comprising:
a compression wave generator; and
a controller having means to actuate the generator to cause a wave in the sample liquid as the positive displacement pump completes delivery of the sample liquid to the dispensing tip.

10. A dispensing assembly as claimed in claim 1, comprising:
a compression wave generator for causing a compression wave to be generated in the system liquid for transfer through the divider barrier and hence into the sample liquid; and
a controller having means to actuate the generator to cause a compression wave in the sample liquid as the positive displacement pump completes delivery of the sample liquid to the dispensing tip.

11. A dispensing assembly as claimed in claim 1, in which the positive displacement pump comprises an assembly of at least two pumps installed in parallel, one pump having a working stroke displacing a volume at least about ten times larger than that of the other pump.

12. A dispensing assembly as claimed in claim 1, comprising:
at least two positive displacement pumps connected in parallel, one pump having a working stroke displacing a volume at least about ten times larger than that of the other pump;
a two part body forming the dispenser body, namely an inner part and a nozzle mounting part, housing respectively a system liquid reservoir portion and a sample liquid reservoir together forming the main bore;
means for mounting the divider barrier between the two parts;
means for connecting the two portions together;
a plurality of nozzles in the mounting part; and
the divider barrier additionally separating portion of the main bore adjacent each nozzle entrance to form separate sample liquid reservoirs divided from the one system liquid reservoir.

13. A dispensing assembly as claimed in claim 1, comprising:
at least two positive displacement pumps connected in parallel, one pump having a working stroke displacing a volume at least about ten times larger than that of the other pump;
a two part body forming the dispenser body, namely an inner part and a nozzle mounting part, housing respectively a system liquid reservoir and a sample liquid reservoir together forming the main bore;
means for mounting the divider barrier between the two parts;
means for releasably connecting the two portions together;
a plurality of nozzles in the mounting part; and
the divider barrier additionally separating portion of the main bore adjacent each nozzle entrance to form separate sample liquid reservoirs divided from the one system liquid reservoir by individual divider barriers, the divider barriers forming at least two sets of divider barriers, each set having different elastomeric properties.

14. A dispensing assembly as claimed in claim 1, comprising:
at least two positive displacement pumps connected in parallel, one pump having a working stroke displacing a volume at least about ten times larger than that of the other pump;
a two part body forming the dispenser body, namely an inner part and a nozzle mounting part, housing respectively a system liquid reservoir and a sample liquid reservoir together forming the main bore;
means for mounting the divider barrier between the two parts;
means for connecting the two parts together;
a plurality of nozzles in the mounting part; and
the dimensions of the divider barrier and the main bore being such as to fit closely in the sample liquid reservoir and across and against the nozzle entrance under the influence of the system liquid.

15. A dispensing assembly as claimed in claim 1, in which the dispenser body comprises:
an inner part having a system liquid reservoir forming some of the main bore;
a nozzle mounting part having a sample liquid reservoir forming the remainder of the main bore;
a divider barrier comprising at least two closely contacting members at least one member being secured to each of the parts.

16. A dispensing assembly as claimed in claim 1, comprising a separate system liquid pressurising means for the rapid expulsion of sample liquid.

17. A dispensing assembly as claimed in claim 1, in which the dispenser body comprises a two part body, namely an inner part and a nozzle mounting part, housing respectively a system liquid reservoir and a sample liquid reservoir forming the main bore, means for mounting the divider barrier between the two parts and means for connecting the two portions together.

18. A dispensing assembly as claimed in claim 1, comprising:
a compression wave generator for causing a compression wave to be generated in the system liquid for transfer through the divider barrier and hence into the sample liquid; and
a controller having means to actuate the generator to cause a wave in the sample liquid as the positive displacement pump completes delivery of the sample liquid to the dispensing tip.

19. A dispensing assembly as claimed in claim 1, comprising:
a piezoactuator for causing a sudden compression of portion of the assembly carrying the system liquid and hence causing a compression wave to be generated in the system liquid for transfer through the divider barrier and hence into the sample liquid; and
a controller having means to operate the piezoactuator to cause the compression wave in the sample liquid as the positive displacement pump completes delivery of the sample liquid to the dispensing tip.

20. A dispensing assembly as claimed in claim 1, comprising:
a magnetostrictive actuator for causing a sudden compression of portion of the assembly carrying the system liquid and hence causing a compression wave to be generated in the system liquid for transfer through the divider barrier and hence into the sample liquid; and
a controller having means to operate the magnetostrictive actuator to cause a compression wave in the sample liquid as the positive displacement pump completes delivery of the sample liquid to the dispensing tip.

21. A dispensing assembly as claimed in claim 1 comprising a magnetostatic actuator including a magnetic core and a magnetic coil coupled together for causing a sudden compression of portion of the assembly carrying the system liquid and hence causing a compression wave to be generated in the system liquid for transfer through the divider barrier and hence into the sample liquid and a controller having means to operate the magnetostatic actuator to cause a compression wave in the sample liquid as the positive displacement pump completes delivery of the sample liquid to the dispensing tip.

22. A dispensing assembly as claimed in claim 1, in which the divider barrier is housed in the main bore dividing it into a system liquid reservoir and a sample liquid reservoir and the shape of the divider barrier and the main bore being such that substantially all the sample liquid can be expelled by means of the positive displacement pump.

23. A dispensing assembly as claimed in claim 1, in which the dispenser body mounts a plurality of nozzles and the divider barrier additionally separates portion of the main bore adjacent each nozzle entrance to form separate sample liquid reservoirs divided from the one system liquid reservoir and the divider barrier is pre-stretched.

24. A dispensing assembly as claimed in claim 22, in which the dispenser body mounts a plurality of nozzles and the divider barrier additionally separates portion of the main bore adjacent each nozzle entrance to form separate sample liquid reservoirs divided from the one system liquid reservoir by individual divider barriers, the divider barriers forming at least two sets of divider barriers, each set having different elastomeric properties and the divider barrier is pre-stretched.

25. A dispensing assembly as claimed in claim 22, comprising:
a compression wave generator for causing a compression wave to be generated in the system liquid for transfer through the divider barrier and hence into the sample liquid; and
a controller having means to actuate the generator to cause the compression wave in the sample liquid as the positive displacement pump completes delivery of the sample liquid to the dispensing tip.

26. A dispensing assembly as claimed in claim 22, comprising:
a piezoactuator for causing a sudden compression of portion of the assembly carrying the system liquid and hence causing a compression wave to be generated in the system liquid for transfer through the divider barrier and hence into the sample liquid; and
a controller having means to operate the piezoactuator to cause the compression wave in the sample liquid as the positive displacement pump completes delivery of the sample liquid to the dispensing tip.

27. A dispensing assembly as claimed in claim 22, comprising:
a magnetostrictive actuator for causing a sudden compression of portion of the assembly carrying the system liquid and hence causing a compression wave to be generated in the system liquid for transfer through the divider barrier and hence into the sample liquid; and
a controller having means to operate the magnetostrictive actuator to cause a compression wave in the sample liquid as the positive displacement pump completes delivery of the sample liquid to the dispensing tip.

28. A dispensing assembly as claimed in claim 22, in which the nozzle mounting part and divider barrier form the one sealed sub-assembly.

29. A dispensing assembly as claimed in claim 22, in which the dispenser body mounts a plurality of nozzles and the divider barrier additionally separates portion of the main bore adjacent each nozzle entrance to form separate sample liquid reservoirs divided from the one system liquid reservoir.

30. A dispensing assembly as claimed in claim 1, in which the dispenser body mounts a plurality of nozzles and the divider barrier additionally separates portion of the main bore adjacent each nozzle entrance to form separate sample liquid reservoirs divided from the one system liquid reservoir by individual divider barriers, the divider barriers forming at least two sets of divider barriers, each set having different elastomeric properties.

31. A dispensing assembly as claimed in claim 30 comprising;
an electrode electrically coupled to each dispensing tip;
a separate receiving electrode below each tip; and
a high voltage generating means connected to at least one of each of the pairs of electrodes to provide an electrostatic field between each tip and corresponding receiving electrodes.

32. A dispensing assembly as claimed in claim 30 comprising:
an electrode electrically coupled to each dispensing tip;
a separate receiving electrode for each of the tips remote from each tip;
a high voltage generating means connected to at least one of each of the pairs of electrodes to provide an electrostatic field between each tip and corresponding receiving electrodes; and
a droplet receiving substrate mounted between the receiving electrodes and the dispensing tips.

33. A dispensing assembly as claimed in claim 30 comprising;
an electrode electrically coupled to each dispensing tip;
a separate receiving electrode for each of the tips remote from each tip including a hole for the passage of a droplet therethrough;
a droplet receiving substrate mounted below the receiving electrodes; and
a high voltage generating means connected to at least one of each of the pair of electrodes to provide an electrostatic field between each tip and corresponding receiving electrodes.

34. A dispensing assembly as claimed in claim 30 comprising;
an electrode electrically coupled to each dispensing tip;
a separate receiving electrode for each of the tips remote from the tip;
a droplet receiving substrate mounted below the receiving electrode;
a high voltage generating means connected to at least one of either the electrodes in each tip or the receiving electrode to provide an electrostatic field therebetween; and
synchronous indexing means for the dispenser and the receiving electrode for accurate deployment of droplets on the substrate.

35. A dispensing assembly as claimed in claim 30 comprising;
an electrode electrically coupled to each dispensing tip;
a plurality of separate receiving electrodes forming droplet deflection electrodes remote from the tips;
a droplet receiving substrate mounted below the deflection electrodes;
a high voltage generating means connected to at least one of the deflection electrodes to provide an electrostatic field therebetween; and
control means to vary the voltage applied to the deflection electrodes.

36. A dispensing assembly as claimed in claim 30, in which the positive displacement pump comprises an assembly of at least two pumps connected in parallel, one pump having a working stroke displacing a volume at least about ten times larger than that of the other pump.

37. A dispensing assembly as claimed in claim 30, comprising:
at least two positive displacement pumps, one pump having a working stroke displacing a volume about at least ten times larger than that of the other pump;
a two part body forming the dispenser body, namely an inner part and a nozzle mounting part, housing respectively a system liquid reservoir and a sample liquid reservoir together forming the main bore;
means for mounting the divider barrier between the two parts; and
means for connecting the two parts together.

38. A dispensing assembly as claimed in claim 30, comprising:
at least two positive displacement pumps, one pump having a working stroke displacing a volume at least about ten times larger than that of the other pump;
a two part body forming the dispenser body, namely an inner part and a nozzle mounting part, housing respectively a system liquid reservoir and a sample liquid reservoir together forming the main bore;
means for mounting the divider barrier between the two parts;
means for connecting the two parts together;
and in which the dimensions of the divider barrier and the main bore are such as to fit closely in the sample liquid reservoir and across and against the nozzle entrance under the influence of the system liquid.

39. A dispensing assembly as claimed in claim 30, in which the divider barrier comprises at least two closely contacting members at least one member being secured to each of the parts.

40. A dispensing assembly as claimed in claim 30, comprising a separate system liquid pressurising means for the rapid expulsion of sample liquid.

41. A dispensing assembly as claimed in claim 1, in which the dispenser body houses the divider barrier therein and the dimensions of the divider barrier and the main bore are such that the system liquid can cause the divider barrier to lie against all of the main bore between the barrier and the nozzle entrance thus expelling essentially all the sample liquid.

42. A dispensing assembly as claimed in claim 41, comprising:
a compression wave generator for causing a compression wave to be generated in the system liquid for transfer through the divider barrier and hence into the sample liquid; and
a controller having means to actuate the generator to cause the compression wave in the sample liquid as the positive displacement pump completes delivery of the sample liquid to the dispensing tip.

43. A dispensing assembly as claimed in claim 41, comprising:
a piezoactuator for causing a sudden compression of portion of the assembly carrying the system liquid and hence causing a compression wave to be generated in the system liquid for transfer through the divider barrier and hence into the sample liquid; and
a controller having means to operate the piezoactuator to cause the compression wave in the sample liquid as the positive displacement pump completes delivery of the sample liquid to the dispensing tip.

44. A dispensing assembly as claimed in claim 41, comprising:
a magnetostrictive actuator for causing a sudden compression of portion of the assembly carrying the system liquid and hence causing a compression wave to be generated in the system liquid for transfer through the divider barrier and hence into the sample liquid; and
a controller having means to operate the magnetostrictive actuator to cause a compression wave in the sample liquid as the positive displacement pump completes delivery of the sample liquid to the dispensing tip.

45. A dispensing assembly as claimed in claim 41 comprising a magnetostatic actuator including a magnetic core and a magnetic coil coupled together for causing a sudden compression of portion of the assembly carrying the system liquid and hence causing a compression wave to be generated in the system liquid for transfer through the divider barrier and hence into the sample liquid and a controller having means to operate the magnetostatic actuator to cause a compression wave in the sample liquid as the positive displacement pump completes delivery of the sample liquid to the dispensing tip.

46. A dispensing assembly as claimed in claim 41, in which the dispenser body mounts a plurality of nozzles and the divider barrier additionally separates portion of the main bore adjacent each nozzle entrance to form separate sample liquid reservoirs divided from the one system liquid reservoir.

47. A dispensing assembly as claimed in claim 41, in which the dispenser body mounts a plurality of nozzles and the divider barrier additionally separates portion of the main bore adjacent each nozzle entrance to form separate sample liquid reservoirs divided from the one system liquid reservoir by individual divider barriers, the divider barriers forming at least two sets of divider barriers, each set having different elastomeric properties.

48. A dispensing assembly as claimed in claim 41 comprising;
an electrode electrically coupled to the dispensing tip;
a separate receiving electrode below the tip; and
a high voltage generating means connected to at least one of the electrodes to provide an electrostatic field therebetween.

49. A dispensing assembly as claimed in claim 41 comprising:
an electrode electrically coupled to the dispensing tip;
a separate receiving electrode remote from the tip;
a high voltage generating means connected to at least one of the electrodes to provide an electrostatic field therebetween; and
a droplet receiving substrate mounted between the receiving electrode and the dispensing tip.

50. A dispensing assembly as claimed in claim 41 comprising;
an electrode electrically coupled to the dispensing tip;
a separate receiving electrode remote from the tip including a hole for the passage of a droplet therethrough;
a droplet receiving substrate mounted below the receiving electrode; and
a high voltage generating means connected to at least one of the electrodes to provide an electrostatic field therebetween.

51. A dispensing assembly as claimed in claim 41 comprising;
an electrode electrically coupled to the dispensing tip;
a separate receiving electrode remote from the tip;
a droplet receiving substrate mounted above the receiving electrode;
a high voltage generating means connected to at least one of the electrodes to provide an electrostatic field therebetween; and
synchronous indexing means for the dispenser and the receiving electrode for accurate deployment of droplets on the substrate.

52. A dispensing assembly as claimed in claim 41 comprising;
an electrode electrically coupled to the dispensing tip;
a plurality of separate receiving electrodes and droplet deflection electrodes remote from the tip;
a droplet receiving substrate mounted above some of the electrodes;
a high voltage generating means connected to at least one of the electrodes to provide an electrostatic field therebetween; and
control means to vary the voltage applied to the deflection and receiving electrodes.

53. A dispensing assembly as claimed in claim 41, in which the positive displacement pump comprises an assembly of at least two pumps connected in parallel, one pump having a working stroke displacing a volume at least about ten times larger than that of the other pump.

54. A dispensing assembly as claimed in claim 41, comprising:
at least two positive displacement pumps connected in parallel, one pump having a working stroke displacing a volume at least about ten times larger than that of the other pump;
a two part body forming the dispenser body, namely an inner part and a nozzle mounting part, housing respectively a system liquid reservoir and a sample liquid reservoir together forming the main bore;
means for mounting the divider barrier between the two parts;
means for connecting the two parts together;
a plurality of nozzles in the mounting part; and
the divider barrier additionally separating portion of the main bore adjacent each nozzle entrance to form separate sample liquid reservoirs divided from the one system liquid reservoir.

55. A dispensing assembly as claimed in claim 41, comprising:
at least two positive displacement pumps connected in parallel, one pump having a working stroke displacing a volume at least about ten times larger than that of the other pump;
a two part body forming the dispenser body, namely an inner part and a nozzle mounting part, housing respectively a system liquid reservoir and a sample liquid reservoir together forming the main bore;
means for mounting the divider barrier between the two parts;
means for connecting the two parts together;
a plurality of nozzles in the mounting part; and
the divider barrier additionally separating portion of the main bore adjacent each nozzle entrance to form separate sample liquid reservoirs divided from the one system liquid reservoir by individual divider barriers, the divider barriers forming at least two sets of divider barriers, each set having different elastomeric properties.

56. A dispensing assembly as claimed in claim 41, comprising:
at least two positive displacement pumps connected in parallel, one pump having a working stroke displacing a volume at least about ten times larger than that of the other pump;
a two part body forming the dispenser body, namely an inner part and a nozzle mounting part, housing respectively a system liquid reservoir and a sample liquid reservoir together forming the main bore;
means for mounting the divider barrier between the two parts;
means for connecting the two parts together;
a plurality of nozzles in the mounting part; and
the dimensions of the divider barrier and the main bore being such as to fit closely in the sample liquid reservoir and across and against the nozzle entrance for each of the nozzles under the influence of the system liquid.

57. A dispensing assembly as claimed in claim 41, in which the divider barrier comprises at least two closely contacting members at least one member being secured to each of the parts.

58. A dispensing assembly as claimed in claim 41, comprising a separate system liquid pressurising means for the rapid expulsion of sample liquid.

59. A dispensing assembly as claimed in claim 1, in which the dispenser body comprises:
an inner part having a system liquid reservoir forming some of the main bore;
a nozzle mounting part having a sample liquid reservoir forming the rest of the main bore; and
means for releasably connecting the two parts together with the divider barrier sandwiched therebetween, the dimensions of the divider barrier and the main bore being such as to fit closely together in the sample liquid reservoir and across and against the nozzle entrance under the influence of the system liquid.

60. A dispensing assembly as claimed in claim 59, comprising:
a compression wave generator for causing a compression wave to be generated in the system liquid for transfer through the divider barrier and hence into the sample liquid; and
a controller having means to actuate the generator to cause a compression wave in the sample liquid as the positive displacement pump completes delivery of the sample liquid to the dispensing tip.

61. A dispensing assembly as claimed in claim 59, in which the dispenser body mounts a plurality of nozzles and the divider barrier additionally separates portion of the main bore adjacent each nozzle entrance to form separate sample liquid reservoirs divided from the one system liquid reservoir.

62. A dispensing assembly as claimed in claim 59, in which the dispenser body mounts a plurality of nozzles and the divider barrier additionally separates portion of the main bore adjacent each nozzle entrance to form separate sample liquid reservoirs divided from the one system liquid reservoir by individual divider barriers, the divider barriers forming at least two sets of divider barriers, each set having different elastomeric properties.

63. A dispensing assembly as claimed in claim 1, in which the dispenser body comprises:
an inner part having a system liquid reservoir forming some of the main bore;
a nozzle mounting part having a sample liquid reservoir forming the remainder of the main bore, the sample liquid reservoir adjacent the nozzle entrance being concave;
means for connecting the two parts together with the divider barrier sandwiched therebetween, the dimensions of the divider barrier and the main bore being such as to fit closely together in the main bore of the sample liquid reservoir and across and adjacent the nozzle entrance under the influence of the system liquid.

64. A dispensing assembly as claimed in claim 63, in which the mounting part, divider barrier and nozzle form the one sealed sub-assembly.

65. A dispensing assembly as claimed in claim 63, comprising:
a compression wave generator for causing a compression wave to be generated in the system liquid for transfer through the divider barrier and hence into the sample liquid; and
a controller having means to actuate the generator to cause a compression wave in the sample liquid as the positive displacement pump completes delivery of the sample liquid to the dispensing tip.

66. A dispensing assembly as claimed in claim 63, comprising:
a piezoactuator for causing a sudden compression of portion of the assembly carrying the system liquid and hence causing a compression wave to be generated in the system liquid for transfer through the divider barrier and hence into the sample liquid; and
a controller having means to operate the piezoactuator to cause a compression wave in the sample liquid as the positive displacement pump completes delivery of the sample liquid to the dispensing tip.

67. A dispensing assembly as claimed in claim 63, comprising:
a magnetostrictive actuator for causing a sudden compression of portion of the assembly carrying the system liquid and hence causing a compression wave to be generated in the system liquid for transfer through the divider barrier and hence into the sample liquid; and
a controller having means to operate the magnetostrictive actuator to cause a compression wave in the sample liquid as the positive displacement pump completes delivery of the sample liquid to the dispensing tip.

68. A dispensing assembly as claimed in claim 63 comprising a magnetostatic actuator including a magnetic core and a magnetic coil coupled together for causing a sudden compression of portion of the assembly carrying the system liquid and hence causing a compression wave to be generated in the system liquid for transfer through the divider barrier and hence into the sample liquid and a controller having means to operate the magnetostatic actuator to cause a compression wave in the sample liquid as the positive displacement pump completes delivery of the sample liquid to the dispensing tip.

69. A dispensing assembly as claimed in claim 63 comprising:
an electrode electrically coupled to the dispensing tip;
a separate receiving electrode remote from the tip; and
a high voltage generating means connected to at least one of the electrodes to provide an electrostatic field therebetween.

70. A dispensing assembly as claimed in claim 63, comprising:
an electrode electrically coupled to the dispensing tip;
a separate receiving electrode remote from the tip; and
a high voltage generating means connected to at least one of the electrodes to provide an electrostatic field therebetween; and
a droplet receiving substrate mounted between the receiving electrode and the dispensing tip.

71. A dispensing assembly as claimed in claim 63, comprising:
an electrode electrically coupled to the dispensing tip;
a separate receiving electrode remote from the tip including a hole for the passage of a droplet therethrough;
a droplet receiving substrate mounted between the receiving electrode; and
a high voltage generating means connected to at least one of the electrodes to provide an electrostatic field therebetween.

72. A dispensing assembly as claimed in claim 63, comprising:
an electrode electrically coupled to the dispensing tip;
a plurality of separate receiving electrodes remote from the tip each having a hole for the passage of a droplet therethrough;
a droplet receiving substrate mounted between the receiving electrodes;
means for activating the receiving electrodes separately; and
a high voltage generating means connected to at least one of the electrodes to provide an electrostatic field therebetween.

73. A dispensing assembly as claimed in claim 63, in which the dispenser body mounts a plurality of nozzles and the divider barrier additionally separates portion of the main bore adjacent each nozzle entrance to form separate sample liquid reservoirs divided from the one system liquid reservoir and the divider barrier is pre-stretched.

74. A dispensing assembly as claimed in claim 63 comprising;
an electrode electrically coupled to the dispensing tip;
a plurality of separate receiving electrodes and droplet deflection electrodes remote from the tip;
a droplet receiving substrate mounted below the deflection electrodes;
a high voltage generating means connected to at least one of the deflection electrodes and at least one of the receiving electrodes to provide an electrostatic field therebetween; and
control means to vary the voltage applied to the deflection electrodes.

75. A dispensing assembly as claimed in claim 63, in which the positive displacement pump comprises an assembly of at least two pumps connected in parallel, one pump having a working stroke displacing a volume at least about ten times larger than that of the other pump.

76. A dispensing assembly as claimed in claim 63, comprising:
at least two positive displacement pumps connected in parallel, one pump having a working stroke displacing a volume at least about ten times larger than that of the other pump;
a two part body forming the dispenser body, namely an inner part and a nozzle mounting part, housing respectively a system liquid reservoir and a sample liquid reservoir together forming the main bore;
means for mounting the divider barrier between the two parts;
means for connecting the two parts together;
a plurality of nozzles in the mounting part; and
the divider barrier additionally separating portion of the main bore adjacent each nozzle entrance to form separate sample liquid reservoirs divided from the one system liquid reservoir.

77. A dispensing assembly as claimed in claim 63, comprising:
at least two positive displacement pumps connected in parallel, one pump having a working stroke displacing a volume at least about ten times larger than that of the other pump;
a two part body forming the dispenser body, namely an inner part and a nozzle mounting part, housing respectively a system liquid reservoir and a sample liquid reservoir together forming the main bore;
means for mounting the divider barrier between the two parts;
means for connecting the two parts together;
a plurality of nozzles in the mounting part; and
the divider barrier additionally separating portion of the main bore adjacent each nozzle entrance to form separate sample liquid reservoirs divided from the one system liquid reservoir by individual divider barriers, the divider barriers forming at least two sets of divider barriers, each set having different elastomeric properties.

78. A dispensing assembly as claimed in claim 63, comprising:
at least two positive displacement pumps connected in parallel, one pump having a working stroke displacing a volume at least about ten times larger than that of the other pump;
a two part body forming the dispenser body, namely an inner part and a nozzle mounting part, housing respectively a system liquid reservoir and a sample liquid reservoir together forming the main bore;
means for mounting the divider barrier between the two parts;
means for connecting the two parts together;
a plurality of nozzles in the mounting part; and
the dimensions of the divider barrier and the main bore being such as to fit closely in the sample liquid reservoir and across and against the nozzle entrance under the influence of the system liquid.

79. A dispensing assembly as claimed in claim 63, in which the divider barrier comprises at least two closely contacting members at least one member being secured to each of the parts.

80. A dispensing assembly as claimed in claim 63, comprising a separate system liquid pressurising means for the rapid expulsion of sample liquid.

81. A dispensing assembly as claimed in claim 1, in which the dispenser body comprises:
an inner part having a system liquid reservoir forming some of the main bore;
a nozzle mounting part having a sample liquid reservoir forming the remainder of the main bore;
a divider barrier comprising a pair of closely contacting members, one member secured to the inner part and the other member to the nozzle mounting part; and
means for releasably connecting the parts together.

82. A dispensing assembly as claimed in claim 81, comprising:
a compression wave generator for causing a compression wave to be generated in the system liquid for transfer through the divider barrier and hence into the sample liquid; and
a controller having means to actuate the generator to cause a compression wave in the sample liquid as the positive displacement pump completes delivery of the sample liquid to the dispensing tip.

83. A dispensing assembly as claimed in claim 81, in which the dispenser body mounts a plurality of nozzles and the divider barrier additionally separates portion of the main bore adjacent each nozzle entrance to form separate sample liquid reservoirs divided from the one system liquid reservoir.

84. A dispensing assembly as claimed in claim 81, in which the dispenser body mounts a plurality of nozzles and the divider barrier additionally separates portion of the main bore adjacent each nozzle entrance to form separate sample liquid reservoirs divided from the one system liquid reservoir by individual divider barriers, the divider barriers together forming at least two sets of divider barriers, each set having different elastomeric properties.

85. A dispensing assembly as claimed in claim 81 in which the dispenser body mounts a plurality of nozzles and the divider barrier additionally separates portion of the main bore adjacent each nozzle to form separate sample liquid reservoirs divided from the one system liquid reservoir by individual barriers, the assembly comprising:
an electrode electrically coupled to each of the dispensing tips;
a separate receiving electrode below each tip; and
a high voltage generating means connected to at least some of the electrodes to provide an electrostatic field therebetween.

86. A dispensing assembly as claimed in claim 81, in which the dispenser body mounts a plurality of nozzles and the divider barrier additionally separates portion of the main bore adjacent each nozzle to form separate sample liquid reservoirs divided from the one system liquid reservoir by individual barriers, the assembly comprising:
an electrode electrically coupled to each of the dispensing tips;
separate receiving electrodes remote from the tips;
a high voltage generating means connected to at least some of the electrodes to provide an electrostatic field therebetween; and
a droplet receiving substrate mounted between the receiving electrodes and the dispensing tips.

87. A dispensing assembly as claimed in claim 81 in which the dispenser body mounts a plurality of nozzles and the divider barrier additionally separates portion of the main bore adjacent each nozzle to form separate sample liquid reservoirs divided from the one system liquid reservoir by individual barriers, the assembly comprising:
an electrode electrically coupled to each of the dispensing tips;
a separate receiving electrode remote from each of the tips;
a droplet receiving substrate mounted above the receiving electrodes;
a high voltage generating means connected to at least one of the electrodes to provide an electrostatic field therebetween; and
synchronous indexing means for the dispenser and the receiving electrodes for accurate deployment of droplets on the substrate.

88. A dispensing assembly as claimed in claim 81 in which the dispenser body mounts a plurality of nozzles and the divider barrier additionally separates portion of the main bore adjacent each nozzle to form separate sample liquid reservoirs divided from the one system liquid reservoir by individual barriers, the assembly comprising:
an electrode electrically coupled to each of the dispensing tips;
a plurality of separate receiving electrodes and droplet deflection electrodes remote from the tip;
a droplet receiving substrate mounted below the deflection electrodes;
a high voltage generating means connected to at least one of the electrodes to provide an electrostatic field therebetween; and
control means to vary the voltage applied to the deflection electrodes.

89. A dispensing assembly as claimed in claim 81, in which the positive displacement pump comprises an assembly of at least two pumps connected in parallel, one pump having a working stroke displacing a volume at least about ten times larger than that of the other pump.

90. A dispensing assembly as claimed in claim 81, comprising at least two positive displacement pumps, one pump having a working stroke displacing a volume about at least ten times larger than that of the other pump, the dispenser body mounts a plurality of nozzles and the divider barrier additionally separates portion of the main bore adjacent each nozzle entrance to form separate sample liquid reservoirs divided from the one system liquid reservoir.

91. A dispensing assembly as claimed in claim 81, comprising at least two positive displacement pumps, one pump having a working stroke displacing a volume about at least ten times larger than that of the other pump, the dispenser body mounts a plurality of nozzles and the divider barrier additionally separates portion of the main bore adjacent each nozzle entrance to form separate sample liquid reservoirs divided from the one system liquid reservoir by individual divider barriers, the divider barriers forming at least two sets of divider barriers, each set having different elastomeric properties.

92. A dispensing assembly as claimed in claim 81, comprising a separate system liquid pressurising means for the rapid expulsion of sample liquid.

93. A dispensing assembly as claimed in claim 1, in which the divider barrier is formed from a separate sample liquid container mounted in the dispenser body and connected directly to the nozzle entrance.

94. A dispensing assembly as claimed in claim 93, in which the dispenser body mounts a plurality of nozzles and a separate sample liquid container is connected to each nozzle.

95. A dispensing assembly as claimed in claim 93, in which the dispenser body mounts a plurality of nozzles and a separate sample liquid container is connected to each nozzle, the liquid containers being so formed that there are at least two sets of individual divider barriers having different elastomeric properties.

96. A dispensing assembly as claimed in claim 93, in which the sample liquid container and nozzle form the one sub-assembly releasably connected to the dispenser body.

97. A dispensing assembly as claimed in claim 1, in which the divider barrier is formed from a separate sample liquid container mounted in the dispenser body and the external dimensions of the divider barrier and the main bore are such that the container can collapse on displacement in the main bore to lie across and against the nozzle entrance.

98. A dispensing assembly as claimed in claim 97, in which the dispenser body mounts a plurality of nozzles and a separate sample liquid container is connected to each nozzle.

99. A dispensing assembly as claimed in claim 97, in which the dispenser body mounts a plurality of nozzles and a separate sample liquid container is connected to each nozzle, the liquid containers being so formed that there are at least two sets of individual divider barriers having different elastomeric properties.

100. A dispensing assembly as claimed in claim 97 in which the dispenser body mounts a plurality of separate nozzles and a separate liquid container is connected to each nozzle, the assembly comprising:
an electrode electrically coupled to each dispensing tip;
a separate receiving electrode below each tip; and
a high voltage generating means connected to at least one of the pairs of electrodes to provide an electrostatic field therebetween.

101. A dispensing assembly as claimed in claim 97 in which the dispenser body mounts a plurality of separate nozzles and a separate liquid container is connected to each nozzle, the assembly comprising:
an electrode electrically coupled to each dispensing tip;
a separate receiving electrode remote from each tip;
a high voltage generating means connected to at least one of the pairs of electrodes to provide an electrostatic field therebetween; and
a droplet receiving substrate mounted between the receiving electrode and the dispensing tips.

102. A dispensing assembly as claimed in claim 97 in which the dispenser body mounts a plurality of separate nozzles and a separate liquid container is connected to each nozzle, the assembly comprising:
an electrode electrically coupled to each dispensing tip;
a separate receiving electrode remote from each tip including a hole for the passage of a droplet therethrough;
a droplet receiving substrate mounted above the receiving electrodes; and
a high voltage generating means connected to at least one of the pair of electrodes to provide an electrostatic field therebetween.

103. A dispensing assembly as claimed in claim 97 in which the dispenser body mounts a plurality of separate nozzles and a separate liquid container is connected to each nozzle, the assembly comprising:
an electrode electrically coupled to each dispensing tip;
a separate receiving electrode remote from the tips;
a droplet receiving substrate mounted above the receiving electrode;
a high voltage generating means connected to at least one of the electrodes to provide an electrostatic field therebetween; and
synchronous indexing means for the dispenser and the receiving electrode for accurate deployment of droplets on the substrate.

104. A dispensing assembly as claimed in claim 97 in which the dispenser body mounts a plurality of separate nozzles and a separate liquid container is connected to each nozzle, the assembly comprising:
an electrode electrically coupled to each dispensing tip;
a plurality of separate receiving electrodes and droplet deflection electrodes remote from the tip;
a droplet receiving substrate mounted below the deflection electrodes;
a high voltage generating means connected to at least one of the electrodes to provide an electrostatic field therebetween; and
control means to vary the voltage applied to the electrodes.

105. A dispensing assembly as claimed in claim 97, in which the positive displacement pump comprises an assembly of at least two pumps connected in parallel, one pump having a working stroke displacing a volume at least about ten times larger than that of the other pump.

106. A dispensing assembly as claimed in claim 97, comprising:
at least two positive displacement pumps connected in parallel, the pump having a working stroke displacing a volume at least about ten times larger than that of the other pump;
a two part body forming the dispenser body, namely an inner part and a nozzle mounting part, housing respectively a system liquid reservoir and a sample liquid reservoir together forming the main bore;
means for mounting the divider barrier between the two parts;
means for connecting the two parts together;
a plurality of nozzles in the mounting part; and
the divider barrier additionally separating portion of the main bore adjacent each nozzle entrance to form separate sample liquid reservoirs divided from the one system liquid reservoir.

107. A dispensing assembly as claimed in claim 97, comprising at least two positive displacement pumps connected in parallel, one pump having a working stroke displacing a volume about at least ten times larger than that of the other pump, the dispenser body mounts a plurality of nozzles and the divider barrier additionally separates portion of the main bore adjacent each nozzle entrance to form separate sample liquid reservoirs divided from the one system liquid reservoir by individual divider barriers, the divider barriers forming at least two sets of divider barriers, each set having different elastomeric properties.

108. A dispensing assembly as claimed in claim 97, comprising at least two positive displacement pumps connected in parallel, one pump having a working stroke displacing a volume about at least ten times larger than that of the other pump, the dispenser body mounts a plurality of nozzles and a separate sample liquid container is connected to each nozzle, the liquid containers being so formed such that there are at least two sets of individual divider barriers having different elastomeric properties.

109. A dispensing assembly as claimed in claim 97, comprising a separate system liquid pressurising means for the rapid expulsion of sample liquid.

110. A dispensing assembly for sample liquid droplets of less than 5 μl in volume comprising:
a dispenser body having a main bore;
a divider barrier for separating the main bore into a system liquid reservoir and a sample liquid reservoir and comprising a body of elastomeric substantially incompressible material;
a nozzle mounted on the dispenser body and terminating in a dispensing tip, the nozzle having a nozzle bore with a nozzle entrance communicating with the sample liquid reservoir; and
a positive displacement pump for delivery of metered quantities of system liquid through the assembly to cause the divider barrier to move into and out of the sample liquid reservoir.

111. A dispensing assembly as claimed in claim 110, in which the dispenser body is a two part body such that the sample liquid reservoir, divider barrier and nozzle form the one sealed sub-assembly.

112. A dispensing assembly as claimed in claim 110, in which the dimensions of the divider barrier and the main bore are such that the system liquid can cause the divider barrier to lie against all of the main bore between the barrier and the nozzle entrance.

113. A dispensing assembly as claimed in claim 110, in which the dispenser body comprises a two part body housing respectively a system liquid reservoir and a sample liquid reservoir together forming the main bore with the divider barrier sandwiched therebetween, the external shape of the divider barrier being such as to fit closely in the main bore of the sample liquid reservoir and across and against the nozzle entrance under the influence of the system liquid.

114. A dispensing assembly as claimed in claim 110, in which the external dimensions of the barrier and the main bore are such as to fit closely together in the main bore of the sample liquid reservoir and across and against the nozzle entrance under the influence of the system liquid.

115. A dispensing assembly as claimed in claim 110, comprising:
a compression wave generator for causing a compression wave to be generated in the system liquid for transfer through the divider barrier and hence into the sample liquid; and
a controller having means to actuate the generator to cause the compression wave in the sample liquid as the positive displacement pump completes delivery of the sample liquid to the dispensing tip.

116. A dispensing assembly as claimed in claim 110, comprising:
a piezoactuator for causing a sudden compression of portion of the assembly carrying the system liquid and hence causing the compression wave to be genert+ system liquid for transfer through the divider barrier and hence into the sample liquid; and
a controller having means to operate the piezoactuator to cause a compression wave in the sample liquid as the positive displacement pump completes delivery of the sample liquid to the dispensing tip.

117. A dispensing assembly as claimed in claim 110, comprising:
a magnetostrictive actuator for causing a sudden compression of portion of the assembly carrying the system liquid and hence causing a compression wave to be generated in the system liquid for transfer through the divider barrier and hence into the sample liquid; and
a controller having means to operate the magnetostrictive actuator to cause the compression wave in the sample liquid as the positive displacement pump completes delivery of the sample liquid to the dispensing tip.

118. A dispensing assembly as claimed in claim 110 comprising a magnetostatic actuator including a magnetic core and a magnetic coil coupled together for causing a sudden compression of portion of the assembly carrying the system liquid and hence causing a compression wave to be generated in the system liquid for transfer through the divider barrier and hence into the sample liquid and a controller having means to operate the magnetostatic actuator to cause a compression wave in the sample liquid as the positive displacement pump completes delivery of the sample liquid to the dispensing tip.

119. A dispensing assembly as claimed in claim 110, in which the dispenser body mounts a plurality of nozzles and the divider barrier additionally separates portion of the main bore adjacent each nozzle entrance to form separate sample liquid reservoirs divided from the one system liquid reservoir.

120. A dispensing assembly as claimed in claim 110, in which the dispenser body mounts a plurality of nozzles and the divider barrier additionally separates portion of the main bore adjacent each nozzle entrance to form separate sample liquid reservoirs divided from the one system liquid reservoir by individual divider barriers, the divider barriers forming at least two sets of divider barriers, each set having different elastomeric properties.

121. A dispensing assembly as claimed in claim 110 comprising;
an electrode electrically coupled to the dispensing tip;
a separate receiving electrode below the tip; and
a high voltage generating means connected to at least one of the electrodes to provide an electrostatic field therebetween.

122. A dispensing assembly as claimed in claim 110 comprising:
an electrode electrically coupled to the dispensing tip;
a separate receiving electrode remote from the tip;
a high voltage generating means connected to at least one of the electrodes to provide an electrostatic field therebetween; and
a droplet receiving substrate mounted between the receiving electrode and the dispensing tip.

123. A dispensing assembly as claimed in claim 110 comprising;
an electrode electrically coupled to the dispensing tip;
a separate receiving electrode remote from the tip including a hole for the passage of a droplet therethrough;
a droplet receiving substrate mounted below the receiving electrode; and
a high voltage generating means connected to at least one of the electrodes to provide an electrostatic field therebetween.

124. A dispensing assembly as claimed in claim 110 comprising;
an electrode electrically coupled to the dispensing tip;
a separate receiving electrode remote from the tip;
a droplet receiving substrate mounted above the receiving electrode;
a high voltage generating means connected to at least one of the electrodes to provide an electrostatic field therebetween; and
synchronous indexing means for the dispenser and the receiving electrode for accurate deployment of droplets on the substrate.

125. A dispensing assembly as claimed in claim 110 comprising;
an electrode electrically coupled to the dispensing tip;
a plurality of separate receiving electrodes and droplet deflection electrodes remote from the tip;
a droplet receiving substrate mounted above at least some of the electrodes;
a high voltage generating means connected to at least one of the electrodes to provide an electrostatic field therebetween; and
control means to vary the voltage applied to the deflection electrodes.

126. A dispensing assembly as claimed in claim 110, in which the positive displacement pump comprises an assembly of at least two pumps connected in parallel, one pump having a working stroke displacing a volume at least about ten times larger than that of the other pump.

127. A dispensing assembly as claimed in claim 110, comprising:
at least two positive displacement pumps connected in parallel, one pump having a working stroke displacing a volume at least about ten times larger than that of the other pump;
a two part body forming the dispenser body, namely an inner part and a nozzle mounting part, housing respectively a system liquid reservoir and a sample liquid reservoir together forming the main bore;
means for mounting the divider barrier between the two parts;
means for connecting the two parts together;
a plurality of nozzles in the mounting part; and
the divider barrier additionally separating portion of the main bore adjacent each nozzle entrance to form separate sample liquid reservoirs divided from the one system liquid reservoir.

128. A dispensing assembly as claimed in claim 110, comprising:
at least two positive displacement pumps connected in parallel, the pump having a working stroke displacing a volume at least about ten times larger than that of the other pump;
a two part body forming the dispenser body, namely an inner part and a nozzle mounting part, housing respectively a system liquid reservoir and a sample liquid reservoir together forming the main bore;
means for mounting the divider barrier between the two parts;
means for connecting the two parts together;
a plurality of nozzles in the mounting part; and
the divider barrier additionally separating portion of the main bore adjacent each nozzle entrance to form separate sample liquid reservoirs divided from the one system liquid reservoir by individual divider barriers, the divider barriers forming at least two sets of divider barriers, each set having different elastomeric properties.

129. A dispensing assembly as claimed in claim 110, comprising:
at least two positive displacement pumps connected in parallel, one pump having a working stroke displacing a volume at least about ten times larger than that of the other pump;
a two part body forming the dispenser body, namely an inner part and a nozzle mounting part, housing respectively a system liquid reservoir and a sample liquid reservoir together forming the main bore;
means for mounting the divider barrier between the two parts;
means for connecting the two parts together;
a plurality of nozzles in the mounting part; and
the dimensions of the divider barrier and the main bore being such as to fit closely in the sample liquid reservoir and across and against the nozzle entrance under the influence of the system liquid.

130. A dispensing assembly as claimed in claim 110, comprising a separate system liquid pressurising means for the rapid expulsion of sample liquid.

131. A dispensing assembly for sample liquid droplets of less than 5 μl in volume comprising:
a dispenser body comprising a two-part dispenser body connected together and having a main bore;
a divider barrier for separating the main bore into a system liquid reservoir and a sample liquid reservoir and comprising a body of elastomeric substantially incompressible material;
a nozzle mounted on the dispenser body and terminating in a dispensing tip, the nozzle having a nozzle bore with a nozzle entrance communicating with the sample liquid reservoir;
a positive displacement pump for delivery of metered quantities of system liquid through the assembly to cause the divider barrier move into and out of the sample liquid reservoir.

132. A dispensing assembly as claimed in claim 131, in which the sample liquid reservoir, divider barrier and nozzle form the one sealed sub-assembly.

133. A dispensing assembly as claimed in claim 131, in which the dimensions of the divider barrier are such that the system liquid can cause the divider barrier to lie against all of the main bore between the barrier and the nozzle entrance.

134. A dispensing assembly as claimed in claim 131, in which the dispenser body comprises a connector for releasably joining the two portions together with the divider barrier sandwiched therebetween, the dimensions of the divider barrier and the main bore being such as to fit closely together in the main bore of the sample liquid reservoir and across and against the nozzle entrance under the influence of the system liquid.

135. A dispensing assembly as claimed in claim 131, in which the dimensions of the barrier and the main bore are such as to fit closely together in the main bore of the sample liquid reservoir and across and against the nozzle entrance under the influence of the system liquid.

136. A dispensing assembly as claimed in claim 131, in which the divider barrier comprises:
a pair of closely contacting membranes, one membrane secured to the system liquid reservoir and the other membrane to the sample liquid reservoir, and
means for releasably connecting the portions together.

137. A dispensing assembly as claimed in claim 131, comprising:
a compression wave generator for causing a compression wave to be generated in the system liquid for transfer through the divider barrier and hence into the sample liquid; and
a controller having means to actuate the generator to cause a compression wave in the sample liquid as the positive displacement pump completes delivery of the sample liquid to the dispensing tip.

138. A dispensing assembly as claimed in claim 131, comprising:
a piezoactuator for causing a sudden compression of portion of the assembly carrying the system liquid and hence causing a compression wave to be generated in the system liquid for transfer through the divider barrier and hence into the sample liquid; and
a controller having means to operate the piezoactuator to cause the compression wave in the sample liquid as the positive displacement pump completes delivery of the sample liquid to the dispensing tip.

139. A dispensing assembly as claimed in claim 131, comprising:
a magnetostrictive actuator for causing a sudden compression of portion of the assembly carrying the system liquid and hence causing the compression wave to be generated in the system liquid for transfer through the divider barrier and hence into the sample liquid; and
a controller having means to operate the magnetostrictive actuator to cause a compression wave in the sample liquid as the positive displacement pump completes delivery of the sample liquid to the dispensing tip.

140. A dispensing assembly as claimed in claim 131 comprising a magnetostatic actuator including a magnetic core and a magnetic coil coupled together for causing a sudden compression of portion of the assembly carrying the system liquid and hence causing a compression wave to be generated in the system liquid for transfer through the divider barrier and hence into the sample liquid and a controller having means to operate the magnetostatic actuator to cause a compression wave in the sample liquid as the positive displacement pump completes delivery of the sample liquid to the dispensing tip.

141. A dispensing assembly as claimed in claim 131, in which the dispenser body mounts a plurality of nozzles and the divider barrier additionally separates portion of the main bore adjacent each nozzle entrance to form separate sample liquid reservoirs divided from the one system liquid reservoir.

142. A dispensing assembly as claimed in claim 131, in which the dispenser body mounts a plurality of nozzles and the divider barrier additionally separates portion of the main bore adjacent each nozzle entrance to form separate sample liquid reservoirs divided from the one system liquid reservoir by individual divider barriers, the divider barriers forming at least two sets of divider barriers, each set having different elastomeric properties.

143. A divider barrier as claimed in claim 131, in which the divider barrier comprises at least two closely contacting members, at least one member being secured to each of the parts.

144. A dispensing assembly as claimed in claim 131 comprising;
an electrode electrically coupled to the dispensing tip;
a separate receiving electrode below the tip; and
a high voltage generating means connected to at least one of the electrodes to provide an electrostatic field therebetween.

145. A dispensing assembly as claimed in claim 131 comprising:
an electrode electrically coupled to the dispensing tip;
a separate receiving electrode remote from the tip;
a high voltage generating means connected to at least one of the electrodes to provide an electrostatic field therebetween; and
a droplet receiving substrate mounted between the receiving electrode and the dispensing tip.

146. A dispensing assembly as claimed in claim 131 comprising;
an electrode electrically coupled to the dispensing tip;
a separate receiving electrode remote from the tip including a hole for the passage of a droplet therethrough;
a droplet receiving substrate mounted below the receiving electrode; and
a high voltage generating means connected to at least one of the electrodes to provide an electrostatic field therebetween.

147. A dispensing assembly as claimed in claim 131 comprising;
an electrode electrically coupled to the dispensing tip;
a separate receiving electrode remote from the tip;
a droplet receiving substrate mounted above the receiving electrode;
a high voltage generating means connected to at least one of the electrodes to provide an electrostatic field therebetween; and
synchronous indexing means for the dispenser and the receiving electrode for accurate deployment of droplets on the substrate.

148. A dispensing assembly as claimed in claim 131 comprising;
an electrode electrically coupled to the dispensing tip;
a plurality of separate receiving electrodes forming droplet deflection electrodes remote from the tip;
a droplet receiving substrate mounted above the deflection electrodes;
a high voltage generating means connected to at least one of the deflection electrodes to provide an electrostatic field therebetween; and
control means to vary the voltage applied to the deflection electrodes.

149. A dispensing assembly as claimed in claim 131, in which the positive displacement pump comprises an assembly of at least two pumps connected in parallel, one pump having a working stroke displacing a volume at least about ten times larger than that of the other pump.

150. A dispensing assembly as claimed in claim 131, comprising at least two positive displacement pumps connected in parallel, one pump having a working stroke displacing a volume about at least ten times larger than that of the other pump and in which the divider barrier additionally separates portion of the main bore adjacent each nozzle entrance to form separate sample liquid reservoirs divided from the one system liquid reservoir.

151. A dispensing assembly as claimed in claim 131, comprising at least two positive displacement pumps connected in parallel, one pump having a working stroke displacing a volume about at least ten times larger than that of the other pump and in which the divider barrier additionally separates portion of the main bore adjacent each nozzle entrance to form separate sample liquid reservoirs divided from the one system liquid reservoir by individual divider barriers, the divider barriers forming at least two sets of divider barriers, each set having different elastomeric properties.

152. A dispensing assembly as claimed in claim 131, comprising at least two positive displacement pumps connected in parallel, one pump having a working stroke displacing a volume at least about ten times larger than that of the other pump and in which the dimensions of the divider barrier and the main bore are such as to cause them to fit closely in the sample liquid reservoir and across and against the nozzle entrance under the influence of the system liquid.

153. A dispensing assembly as claimed in claim 131, comprising a separate system liquid pressurising means for the rapid expulsion of sample liquid.

154. A dispensing assembly for liquid droplets of less than 5 μl in volume comprising:
a two part body forming a dispenser body, the two part body comprising an inner part and a nozzle mounting part housing respectively a system liquid reservoir and a sample liquid reservoir forming a main bore;
a divider barrier mounted between the inner part and the nozzle mounting part to separate the liquid reservoirs and comprising a body of elastomeric substantially incompressible material;
a nozzle mounted on the nozzle mounting part and terminating in a dispensing tip, the nozzle having a nozzle bore with a nozzle entrance communicating with the sample liquid reservoir of the main bore; and
at least two positive displacement pumps connected in parallel, one pump having a working stroke displacing a volume at least about ten times more than the volume displaced by the other pump.

155. A dispensing assembly as claimed in claim 154 comprising;
an electrode electrically coupled to the dispensing tip;
a separate receiving electrode remote from the tip; and
a high voltage generating means connected to at least one of the electrodes to provide an electrostatic field therebetween.

156. A dispensing assembly as claimed in claim 154 comprising;
an electrode electrically coupled to the dispensing tip;
a separate receiving electrode below the tip; and
a high voltage generating means connected to at least one of the electrodes to provide an electrostatic field therebetween.

157. A dispensing assembly as claimed in claim 154 comprising:
an electrode electrically coupled to the dispensing tip;
a separate receiving electrode remote from the tip;
a high voltage generating means connected to at least one of the electrodes to provide an electrostatic field therebetween; and
a droplet receiving substrate mounted between the receiving electrode and the dispensing tip.

158. A dispensing assembly as claimed in claim 154 comprising;
an electrode electrically coupled to the dispensing tip;
a separate receiving electrode remote from the tip including a hole for the passage of a droplet therethrough;
a droplet receiving substrate mounted below the receiving electrode; and
a high voltage generating means connected to at least one of the electrodes to provide an electrostatic field therebetween.

159. A dispensing assembly as claimed in claim 154 comprising;
an electrode electrically coupled to the dispensing tip;
a plurality of separate receiving electrodes remote from the tip each having a hole for the passage of a droplet therethrough;
a droplet receiving substrate mounted below the receiving electrodes;
means for activating the receiving electrodes separately; and
a high voltage generating means connected to at least one of the electrodes to provide an electrostatic field therebetween.

160. A dispensing assembly as claimed in claim 154 comprising;
an electrode electrically coupled to the dispensing tip;
a separate receiving electrode remote from the tip;
a droplet receiving substrate mounted above the receiving electrode;
a high voltage generating means connected to at least one of the electrodes to provide an electrostatic field therebetween; and
synchronous indexing means for the dispenser and the receiving electrode for accurate deployment of droplets on the substrate.

161. A dispensing assembly as claimed in claim 154 comprising;
an electrode electrically coupled to the dispensing tip;
a plurality of separate receiving electrodes forming droplet deflection electrodes remote from the tip;
a droplet receiving substrate mounted below the deflection electrodes;
a high voltage generating means connected to at least one of the deflection electrodes to provide an electrostatic field therebetween; and
control means to vary the voltage applied to the deflection electrodes.

162. A dispensing assembly as claimed in claim 154, comprising:
a compression wave generator; and
a controller having means to actuate the generator to cause a wave in the sample liquid as the positive displacement pump displacing the smaller volume completes delivery of the sample liquid to the dispensing tip.

163. A dispensing assembly as claimed in claim 154, comprising:
a compression wave generator for causing a compression wave to be generated in the system liquid for transfer through the divider barrier and hence into the sample liquid; and
a controller having means to actuate the generator to cause a compression wave in the sample liquid as the positive displacement pump placing the smaller volume completes delivery of the sample liquid to the dispensing tip.

164. A dispensing assembly as claimed in claim 154, comprising:
a compression wave generator for causing a compression wave to be generated in the system liquid for transfer through the divider barrier and hence into the sample liquid; and
a controller having means to actuate the generator to cause a wave in the sample liquid as the positive displacement pump placing the smaller volume completes delivery of the sample liquid to the dispensing tip.

165. A dispensing assembly as claimed in claim 154, comprising:
a piezoactuator for causing a sudden compression of portion of the assembly carrying the system liquid and hence causing a compression wave to be generated in the system liquid for transfer through the divider barrier and hence into the sample liquid; and
a controller having means to operate the piezoactuator to cause the compression wave in the sample liquid as the positive displacement pump displacing the smaller volume completes delivery of the sample liquid to the dispensing tip.

166. A dispensing assembly as claimed in claim 154, comprising:
a magnetostrictive actuator for causing a sudden compression of portion of the assembly carrying the system liquid and hence causing a compression wave to be generated in the system liquid for transfer through the divider barrier and hence into the sample liquid; and
a controller having means to operate the magnetostrictive actuator to cause a compression wave in the sample liquid as the positive displacement pump displacing the smaller volume completes delivery of the sample liquid to the dispensing tip.

167. A dispensing assembly as claimed in claim 154 comprising a magnetostatic actuator including a magnetic core and a magnetic coil coupled together for causing a sudden compression of portion of the assembly carrying the system liquid and hence causing a compression wave to be generated in the system liquid for transfer through the divider barrier and hence into the sample liquid and a controller having means to operate the magnetostatic actuator to cause a compression wave in the sample liquid as the positive displacement pump completes delivery of the sample liquid to the dispensing tip.

168. A dispensing assembly as claimed in claim 154, in which the dispenser body mounts a plurality of nozzles and the divider barrier additionally separates portion of the main bore adjacent each nozzle entrance to form separate sample liquid reservoirs divided from the one system liquid reservoir.

169. A dispensing assembly as claimed in claim 149, comprising a separate system liquid pressurising means for the rapid expulsion of sample liquid.

170. A divider barrier as claimed in claim 154, in which the divider barrier comprises at least two closely contacting members, at least one member being secure to each of the parts.
